(19) United States
(12) Patent Application Publication
(10) Pub. No.: US 2010/0080425 A1
(43) Pub. Date: Apr. 1, 2010

(54) Minutiae-based template synthesis and matching

(75) Inventors: George Bebis, Reno, NV (US); Tamer Uz, Reno, NV (US); Ali Erol, Esmirna (TR)

Correspondence Address: HOLLAND & HART, LLP, P.O BOX 8749, DENVER, CO, 80201, US

(73) Assignees: Board of regents of the Nevada System of Higher Education, on Behalf of the University of; Nevada, Reno, Reno, NV (US)

(21) Appl. No.: 12/586,926

(22) Filed: Sep. 29, 2009

Related U.S. Application Data
(60) Provisional application No. 61/194,837, filed on Sep. 29, 2008.

(51) Int. Cl. G06K 9/00

(52) U.S. Cl. 382/125

(57) ABSTRACT

A method of determining a match between a candidate template and a super-template involves using the super-template to identify i) spatial coordinates for a plurality of minutiae that define an object, and ii) a quality associated with each minutiae. For sets of the super-template minutiae having at least two defined minutiae qualities, at least one Delaunay triangle is computed for each set. A match between the candidate template and the super-template is determined by determining a correspondence of Delaunay triangles in the candidate and super-templates, which correspondence results in an alignment of at least some minutiae of the candidate template with at least some minutiae of the super-template. Related methods, articles and apparatus are also disclosed.

### CROSS-REFERENCE TO RELATED APPLICATION

This application claims the benefit of U.S. Provisional Application No. 61/194,837, filed Sep. 29, 2008, which application is hereby incorporated by reference for all that it discloses.

### BACKGROUND

Fingerprint matching is among the most widely used biometric technologies, with a broad range of both government and civilian applications. This is mainly because fingerprints are distinctive [1], are easy to capture, and keep their characteristics for a life-time [2]. Traditionally, fingerprint matching has been used by law enforcement authorities to identify criminals [3]. Today, however, with the availability of low cost fingerprint sensors, fingerprint matching is going beyond criminal identification applications. Examples of fingerprint matching applications include driver's license, social security, passport control, ATM/credit card, and medical records management, as well as laptop and cell phone access control [2].

### SUMMARY

Fingerprint matching is often affected by the presence of intrinsically low quality fingerprints and various distortions introduced during the acquisition process. One way to account for within-class variations is by capturing multiple enrollment impressions of a finger. When multiple impressions of the same finger are available, one can in principle expect to make more reliable decisions about the presence or quality of fingerprint features by combining information from each impression. However, this requires determining how to integrate (or merge) the information from the multiple enrollment impressions. The methods disclosed herein can sometimes be used to combine minutiae information from multiple enrollment impressions of the same finger and can sometimes: increase coverage area, restore missing minutiae, and eliminate or mitigate the effects of spurious minutiae on matching.

Disclosed herein is a novel, minutiae-based, template synthesis method which merges several enrollment templates into a “super-template”. To merge an enrollment template with a super-template, a search can be made for correspondences between the enrollment template and the current super-template using a novel hierarchical matching strategy. In particular, minutiae in the super-template may be assigned a weight which is proportional to their frequency of occurrence in a plurality of enrollment templates. Each weight serves as a minutiae quality measure. In this manner, each super-template can be represented in terms of a hierarchy of Delaunay triangulations, where different levels of the hierarchy correspond to minutiae of different defined minutiae qualities. Matching may be performed hierarchically, starting at the top of the Delaunay triangulation hierarchy, which contains only higher quality minutiae, and moving down to lower levels of the hierarchy—effectively considering lower quality minutiae on an incremental basis. During authentication, the same hierarchical matching strategy can be employed (sometimes with minor modifications) to better handle imposters.

Given the above context, a method of determining a best match between a candidate template and a super-template may sometimes use the super-template to identify i) spatial coordinates for a plurality of minutiae that define an object, and ii) a quality associated with each minutiae. For each of a plurality of iterations, wherein each iteration is associated with one of a plurality of defined minutiae qualities, the method A) determines a correspondence between i) minutiae identified by the candidate template, and ii) minutiae in the super-template having the defined minutiae quality; and B) registers the candidate template with the super-template in response to the determined correspondence. In response to one or more match criteria, one of the registrations between the candidate template and the super-template is identified as a best match between the candidate template and the super-template. The defined minutiae qualities may include overlapping or non-overlapping sets of minutiae. In one embodiment, a first set includes minutiae of a highest quality, a second set includes the minutiae of the first set plus minutiae of a next highest quality, and so on. The last set (or second set, if it is the last) may include minutiae of all qualities.

Depending on its implementation, the method described in the preceding paragraph can be used to limit the effects of missing or spurious minutiae when attempting to match a candidate template to a super-template. The method can be especially useful in the context of fingerprint matching based on Delaunay triangulations, wherein the method can limit the effect that spurious minutiae have on creating spurious (versus “true”) Delaunay triangles.

In the specific context of Delaunay triangles, a method of determining a match between a candidate template and a super-template may use the super-template to identify i) spatial coordinates for a plurality of minutiae that define an object, and ii) a quality associated with each minutiae. For sets of the super-template minutiae having at least two defined minutiae qualities, at least one Delaunay triangle may be computed for each set. A match between the candidate template and the super-template may then be determining by determining a correspondence of Delaunay triangles in the candidate and super-templates, which correspondence of Delaunay triangles results in an alignment of at least some minutiae of the candidate template with at least some minutiae of the super-template. Note that some of the minutiae of the super-template may be included in more than one of the “sets of super-template minutiae”.

In the case of fingerprint matching, the matching methods disclosed above may be used to either: 1) match an enrollment template to a super-template so that the spatial coordinates of the minutiae in the enrollment template can be merged with the spatial coordinates of the minutiae in the super-template; or 2) authenticate (or reject) a fingerprint as matching the fingerprint associated with a super-template.

In the case of matching an enrollment template to a super-template, so that the spatial coordinates of the minutiae in the enrollment template can be merged with the spatial coordinates of the minutiae in the super-template, a method of synthesizing a super-template for an object may initialize the super-template by i) merging into the super-template a plurality of minutiae specified by a first enrollment template for the object, and ii) associating a minutiae quality with each of the minutiae merged into the super-template. A next enrollment template for the object may then be merged into the super-template by, for each of a plurality of iterations, wherein each iteration is associated with one of a plurality of defined minutiae qualities, A) determining a correspondence between i) minutiae identified by the next template, and ii) minutiae in the super-template having a defined minutiae quality; and B) in response to the determined correspondence, registering the next template with the super-template. Then, in response to one or more match criteria, one of the registrations between the next template and the super-template may be identified as a best match. The registration identified as the best match may be used to merge at least some of the minutiae identified by the next template into the super-template; and the minutiae qualities associated with the minutiae in the super-template may be updated by combining minutiae qualities of corresponding minutiae in the next template and the super-template.

### BRIEF DESCRIPTION OF THE DRAWINGS

Illustrative embodiments of the invention are illustrated in the drawings, in which:

FIG. 1 illustrates two types of minutiae used in fingerprint matching: a ridge ending, and a ridge bifurcation;

FIG. 2 illustrates an image and corresponding line drawing of a fingerprint which is partially distorted (i.e., distorted at the center) due to smudging;

FIG. 3 illustrates a pair of fingerprint images where the overlap between the fingerprints is less than 40% of the overall fingerprint area;

FIG. 4 illustrates an example of matching of minutiae triangles between fingerprints;

FIG. 5 illustrates the Voronoi diagram and Delaunay triangulation for a set of minutiae, overlaid on the corresponding fingerprint image;

FIG. 6 illustrates an example of a minutiae triangle;

FIG. 7 illustrates an example of minutiae features and minutiae triangles that may be extracted from a fingerprint;

FIG. 8 is a schematic diagram illustrating how to handle planarity issues when determining whether minutiae triangles support a transform space;

FIG. 9 shows an example of a structure for holding minutiae and transform details in support of a transformation space;

FIG. 10 illustrates an example of a super-template which was built by merging two enrollment templates;

FIGS. 11(a)-(d) illustrate the effects of missing and/or spurious minutiae, as well as nonlinear distortions, on a Delaunay triangulation;

FIG. 12(d) shows an example of a super-template that may be built by merging the templates shown in FIGS. 12 (a)-(c);

FIGS. 13(a)-(c) illustrate the corresponding Delaunay triangulation hierarchy for the super-template shown in FIG. 12(d);

FIGS. 14(a)-(c) illustrate the benefits of a hierarchical matching approach;

FIG. 15(a) shows the combined triangulations of FIGS. 13(a) and 13(b), while FIG. 15(b) shows the combined triangulations of FIGS. 13(a), 13(b) and 13(c);

FIG. 16 shows an example where the minutiae in FIG. 16(b) need to be registered with the minutiae in FIG. 16(a); where FIG. 16(c) illustrates the results of registering the two sets using a rigid transformation; and where FIG. 16(d) illustrates the results of registration after a single affine refinement;

FIG. 17 illustrates an example of a method for determining a best match between a candidate template and a super-template;

FIG. 18 illustrates average similarity scores between enrollment templates, wherein the upper-left fingerprint has the highest average similarity score, but the lower-right fingerprint is of visually higher quality;

FIG. 19 illustrates a quality index map with minutiae overlaid on it;

FIGS. 20(a)-(d) illustrate how super-template minutiae qualities are updated using the enrollment templates shown in FIG. 21; wherein FIG. 20(a) shows the prime template used to initialize the super-template and FIGS. 20(b)-(d) show how the current super-template is updated;

FIGS. 21(a)-(d) illustrate examples of enrollment templates that are used to update the super-template shown in FIGS. 20(a)-(d);

FIG. 22 illustrates a method of synthesizing a super-template for an object;

FIG. 23 is a block diagram of an example computing system capable of implementing one or more of the methods described and/or illustrated herein;

FIG. 24 is a block diagram of an example of a computing network capable of implementing one or more of the methods described and/or illustrated herein;

FIG. 25 shows several representative fingerprint samples from the FVS2000 Db1 fingerprint database;

FIG. 26 compares the performance of different fingerprint matching methods (i.e., SLF, T_SEL, T_SYN) using different numbers of enrollment templates;

FIG. 27 illustrates the Receiver Operating Characteristics (ROC) curves for (i) Score Level Fusion (SLF), (ii) Template Selection (T_SEL), and (iii) Template Synthesis (T_SYN) fingerprint matching approaches, for different numbers of enrollment templates;

FIG. 28(a) shows a set of 2D points; FIG. 28(b) shows their Voronoi diagram; and FIG. 28(c) shows their Delaunay triangulation.

It is noted that, in the following description, like reference numbers appearing in different drawing figures refer to like elements/features. Often, therefore, like elements/features that appear in different drawing figures will not be described in detail with respect to each of the drawing figures.

### DETAILED DESCRIPTION

Despite the long history and research on fingerprint matching, developing more powerful fingerprint matching algorithms to improve accuracy, robustness, and efficiency is still an active research area. One of the key challenges in fingerprint matching is getting a sufficient or perfect match between a pair of fingerprints from the same person, which can be difficult due to within-class variations. These variations can be caused by several factors, such as non-linear geometric distortions due to skin elasticity, inconsistent finger placement and contact pressure, small sensing area, environmental conditions, and sensor noise. As a result, impressions of the same finger can look quite different from each other, making which can make matching difficult. For example, distortions in the ridge structure can result in missing/spurious minutiae, while a small sensing area can make it difficult to register two fingerprints due to the small overlap between the fingerprints. As used herein, minutiae are details that aid in defining an object. In the case of fingerprints, minutiae may include ridge endings or bifurcations.

Capturing multiple enrollment impressions can be an effective approach to account for within-class variation of fingerprints. In general, information from multiple enrollment impressions can be integrated in two different ways for matching purposes. The first approach involves matching a given impression (i.e., query) against each of the enrollment impressions. The final matching is obtained by fusing the individual matching results either at the score level (e.g., maximum score) or at the decision level (e.g. majority voting). The second approach involves merging the enrollment impressions into a “super-fingerprint” by registering the enrollment impressions together and matching the query against the super-fingerprint. The first approach has shown to increase accuracy to desired levels, however, it can increase both storage and time requirements. On the other hand, while the second approach can be less space and time consuming, registering the enrollment impressions accurately can be challenging.

Merging a number of enrollment impressions into a super-fingerprint can increase fingerprint area and compensates for low quality impressions. In general, merging can be done either at the image level or at the minutiae level. Image level merging, also known as “mosaicking”, creates a super-fingerprint image by registering the enrollment impressions. The resulting super-fingerprint image is typically useable with any fingerprint matching algorithm, however, nonlinear distortions may degrade the quality of the super-fingerprint. Minutiae level merging creates a super-fingerprint template (i.e., a “super-template”) by registering the corresponding enrollment minutiae templates. This approach is simpler in general and can tolerate nonlinear distortions better than image mosaicking, however, the resulting super-template can typically be used only with minutiae-based, fingerprint matching algorithms.

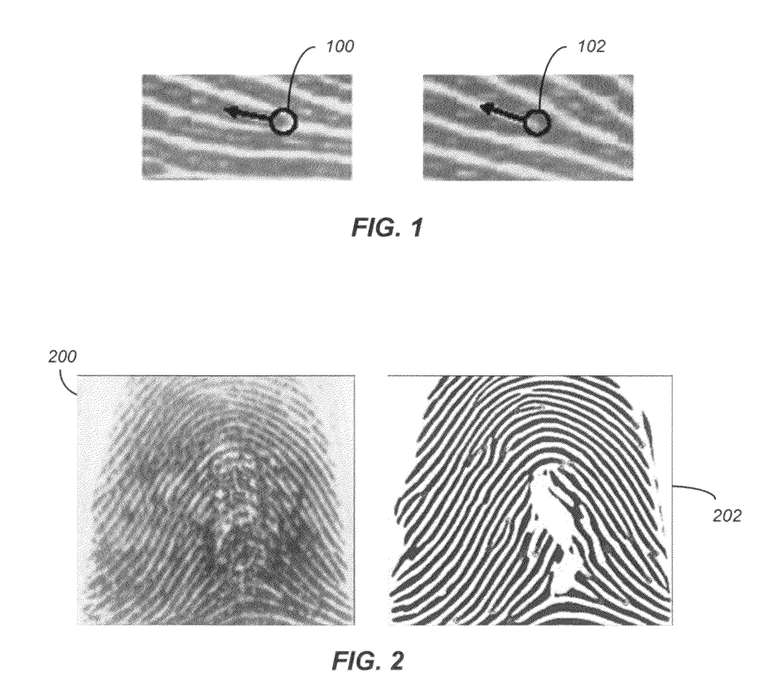

Following is a discussion of fingerprint matching, in general. Currently, there are two main approaches to fingerprint matching: (i) image-based, and (ii) feature-based. Image based matching relies on gray-level correlation, however, this approach can be time consuming and may suffer from nonlinear distortions. Feature-based matching involves matching various types of minutiae features such as ridge endings and bifurcations. For example, FIG. 1 illustrates two types of minutiae used in fingerprint matching: a ridge ending 100, and a ridge bifurcation 102. Feature-based methods are usually faster than image-based methods, can tolerate non-linear distortions more successfully, and require less memory.

Several factors affect fingerprint matching, including low-quality images (e.g., due to sensor noise), non-linear geometric distortions (e.g., due to skin elasticity), and sensitivity to the variability in contact pressure and skin condition (e.g., dry or over-moist skin). For example, when a finger is pressed against a scanner surface, different parts of it can touch the surface with non-uniform pressure. In practice, fingerprint images often include incomplete/distorted ridge structures, resulting in missing/spurious minutiae. FIG. 2 shows an image 200 and corresponding line drawing 202 of a fingerprint which is partially distorted (i.e., distorted at the center) due to smudging. As a result, spurious minutiae have been introduced around the distorted area, while some “true” minutiae have not been detected.

One way to deal with the above issues is by representing each finger (i.e., object) with multiple enrollment impressions. In principle, when more than one impression of the same finger is available, one can expect to make more reliable decisions about the identity of a person given a new impression [6]. One issue, however, is how to integrate information from multiple enrollment impressions. One way to do so is by comparing new impressions to every enrollment impression and then arbitrating the results. For example, binary matching results (i.e., matched/unmatched) can be arbitrated using decision-level fusion (e.g., AND/OR logical operators). Alternatively, matching scores can be combined using score-level fusion (e.g., weighted average).

In general, when an appropriate fusion function is chosen, score-level fusion performs well in terms of accuracy. However, systems employing decision-level or score-level fusion need to store multiple impressions of the same finger which, besides increasing storage and time requirements, can increase redundancy. Therefore, score-level fusion, although producing good results, might not be appropriate for certain applications.

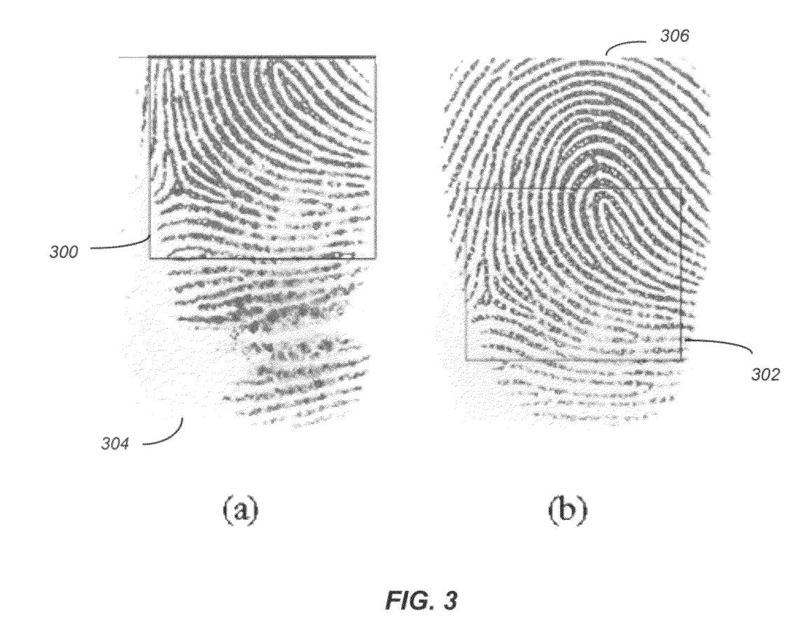

One way to decrease space and time requirements while maintaining the accuracy of score-level fusion is by merging the enrollment impressions into a “super-fingerprint”. This can eliminate redundancy while improving storage requirements and verification time, since new impressions need only be compared with the super-fingerprint. Moreover, merging a set of enrollment impressions into a super-fingerprint may be used to address the small overlapping area problem. This problem appears often in practice due to inconsistent placement of the finger on the sensor surface (i.e., different parts of the finger could be captured in each acquisition) or due to employing sensors with small scanning surface or different types of sensors (i.e., inter-operability problems). FIG. 3 shows an example where the overlapping area 300, 302 between two fingerprints 304, 306 from the same finger is less than 40% of the overall fingerprint area.

Algorithms that combine multiple impressions are based on two main approaches: (i) mosaicking [7]-[8], which combines the enrollment impressions at the image level, and (ii) template synthesis [9][6], which combines the enrollment impressions at the minutiae (i.e., feature) level.

In [7], Ratha et al. used several blending algorithms to tile the image sequence of a rolling fingerprint grabbed by a large area scanner. Since the images were obtained by rolling the fingerprint on the sensor, successive images were assumed to be spatially registered. In [10], Jain and Ross combined multiple enrollment impressions by aligning the ridges of two images using the iterative closest point (ICP) algorithm. One potential drawback of that work is that they did not account for non-linear deformations. In [11], Zhang et al. mosaicked the stream of swipe fingerprint frames using a minimum mean absolute error criterion. One potential drawback of this technique is that it cannot handle rotation, scale, or shear in individual frames of the swipe, fingerprint images. Moreover, it typically does not take into consideration non-linear deformations.

Choi et al. [12] describe mosaicking different parts of a fingerprint which were collected by having the subject roll and slide his/her finger on the surface of a small area fingerprint scanner. Rolling and sliding over a small area sensor, however, could cause severe plastic distortion and smudging, which may have degraded the performance of their system. Although they investigated the small overlapping area problem, handling missing/spurious minutiae explicitly was not considered. Shah et al. [8] performed mosaicking by employing a thin plane spline as a transformation model to account for nonlinear distortions in fingerprints. However, they could not get a correct alignment almost 16% of the time; they handled these failures using score-level fusion. Although they showed better results using mosaicking than the individual enrollment impressions, their system is semi-automatic and requires intervention when mosaicking does not work.

Considering template synthesis methods, Yau et al. [13] compared three transformations for aligning two sets of minutiae for template synthesis: affine, projective, and topological. Their results indicated that affine transformation performed better. In terms of matching, they found that template synthesis lowered the number of false rejections. A modified ICP algorithm was used by Moon et al. [14] to search for the optimal registration before merging two minutiae sets. In Ryu et al. [15], a Bayesian estimation approach was used to merge several enrollment minutiae sets. Toh et al. [9] created a synthesized feature set using multiple enrollment templates. Even though they showed improvements using the combined feature set compared to a single template that included the center of the finger, the reported accuracy rates were much lower than current benchmarks.

In [6], Jiang et al. created and updated a super-template as the user provided new samples during verification. That work assigned a weight to each minutiae according to its frequency of occurrence. Depending on the weight values, spurious minutiae could fade away over time, while missing minutiae could appear at some point in time. In contrast to the novel approaches disclosed herein, which use minutiae of various quality for matching, Jiang et al. simply discard low quality minutiae by thresholding the weights. They reported an improvement in accuracy relative to using individual templates; however, no comparisons with other fusion approaches were shown.

In a recent study comparing image mosaicking versus template synthesis using thin-plate splines [16], it was found that both methods improve matching performance, however, template synthesis outperformed image mosaicking. In a related study [14], it was found that image mosaicking worked better than template synthesis when the size of the component images decreased. They justified this result by the fact that the number of spurious minutiae gets smaller as the image size decreases.

I. Fingerprint Matching Using Delaunay Triangulation

Various enrollment templates can be combined into a super-template using an alignment transformation to register each of the enrollment templates with the current super-template. Given a pair of minutiae sets, one from an enrollment template and the other from the super-template, the alignment transformation can be computed by finding corresponding minutiae in the two sets. One matching strategy uses Delaunay triangulation [4], with extensions to account for missing and spurious minutiae.

In the following subsections, fingerprint matching using Delaunay triangulation [4] is discussed. Also, Appendix A reviews Delaunay triangulation and its properties in the context of fingerprint matching.

A. Fingerprint Matching Using Minutiae Triangles

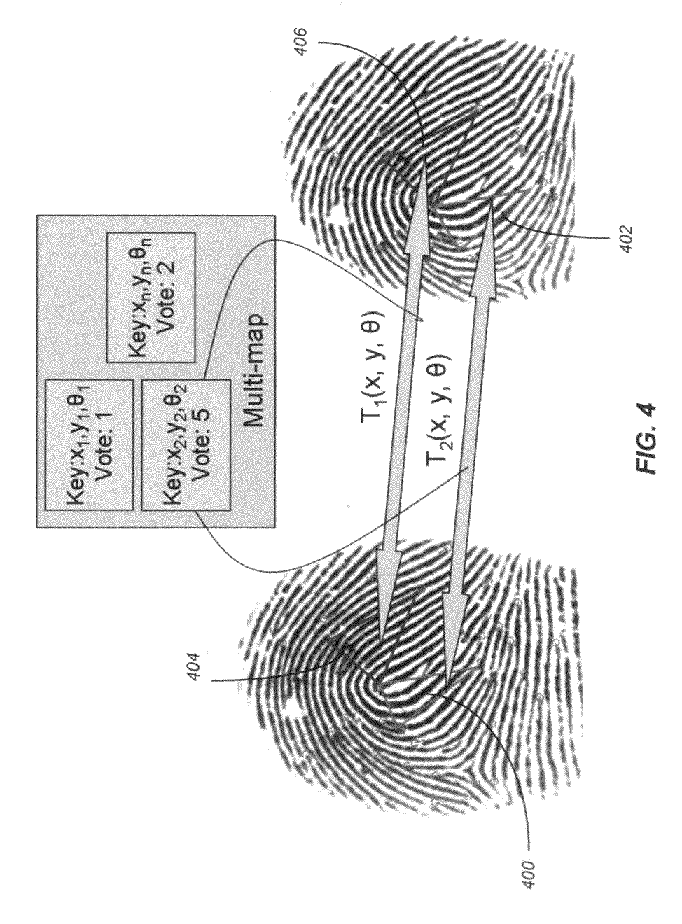

The matching of minutiae triangles represents a common approach to matching a pair of minutiae sets. For example, minutiae triangles 400, 402, 404, 406 (FIG. 4) may be formed from minutiae triplets, and may then be matched using invariant features of the minutiae triangles 400, 402, 404, 406 [23][4]. In general, a pair of minutiae triangles 400, 402 provides enough information to compute a transformation that potentially aligns the minutiae sets. To compute good alignments, voting may be applied in the transformation space to find transformations that are supported by many corresponding (i.e., matched) minutiae triangles. A number of hypothetical transformations may then be found by considering transformations that have received high number of votes. Each hypothetical transformation is explicitly verified by using it to align the minutiae sets and counting the number of overlapping minutiae. The best alignment is the one maximizing the number of overlapping minutiae.

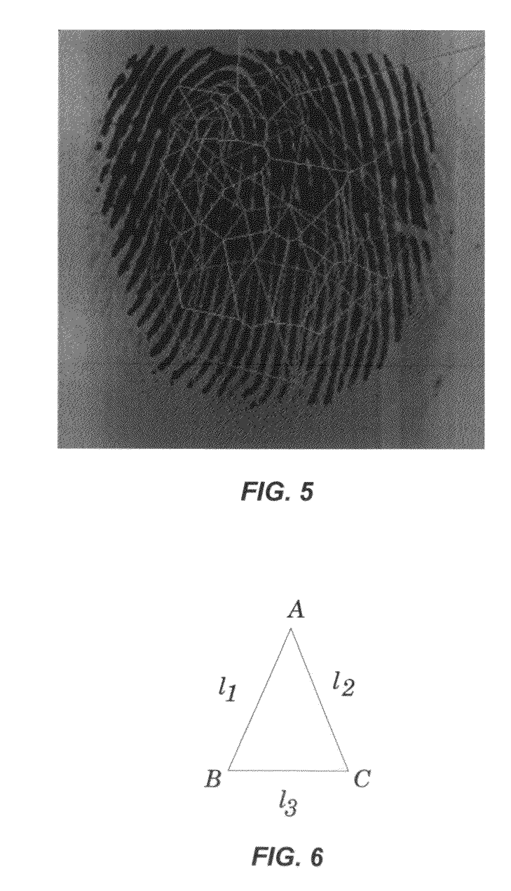

An important issue in matching can be which minutiae triplets to choose in order to form the minutiae triangles. Considering all possible minutiae triplets can be computationally prohibitive since there are O(n³) minutiae triplets. To keep complexity low, Germain et. al. [23] suggested a number of heuristics based on the distance between minutiae. In a later study [4], it was proposed to associate a unique topological structure with the minutiae using Delaunay triangulation, and to use Delaunay triangles for matching. This reduces the number of minutiae triangles to O(n), speeding up matching considerably without affecting accuracy significantly. FIG. 5 shows the Voronoi diagram and Delaunay triangulation of a set of minutiae, overlaid on the corresponding fingerprint image.

B. Invariant Features

Invariant features are features that maintain their relative relationship(s) through rigid transformations of an image (e.g., scaling or rotation).

Once the Delaunay triangulation of a set of minutiae has been computed, two groups of invariant features from each triangle are considered, based on the sides and angles of the triangle. Specifically, given a minutiae triangle (e.g., see FIG. 6), the first group of features, denoted as Vₜ, includes three attributes which are invariant to rigid transformations:

$${V}_{t} = [ \frac{{l}_{1}}{{l}_{3}} , \frac{{l}_{2}}{{l}_{3}} , cos ( A ) ] \qquad ( 1 )$$

where lₓ is the length of triangle side x, where l₁≦l₂≦l₃, and where A is the largest angle of the triangle (i.e., the angle across from the largest-side). The cosine of A may be used instead of A itself, because the cosine is less sensitive to noise. The second group of features, denoted as Vₘ, involves the angles of the minutiae. Specifically, the minutiae forming the triangle can be ordered with respect to the length of the sides across from the angles, so that:

Vₘ=[∠m₁, ∠m₂, ∠m₃] (2)

where mₓ is an angle of the triangle.

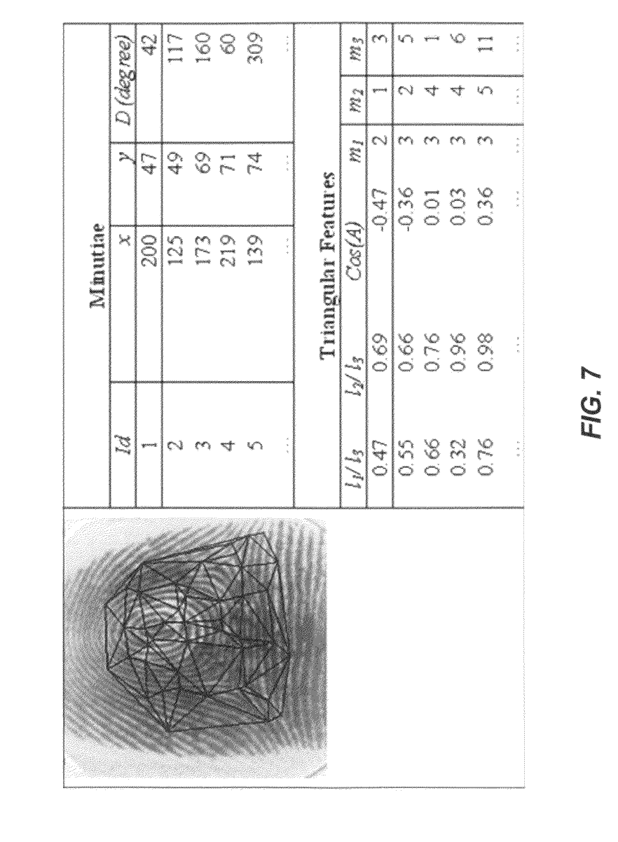

It should be mentioned that very large angles yield triangles whose points are almost collinear (i.e., skinny triangles). Such triangles are not typically desirable, since small errors in minutiae locations can lead to large errors in the computation of the parameters of the alignment transformation. Although the Delaunay triangulation tends to avoid skinny triangles, it is not always guaranteed unless inserting extra points [24]. To deal with this issue, triangles whose largest angle is greater than a threshold (e.g., 168 degrees) can be rejected. FIG. 7 shows an example of the minutiae features and minutiae triangles that may be extracted from a fingerprint. By way of example, each minutiae is denoted by an identifier (Id), spatial coordinates (x and y), and a minutiae orientation (e.g., an angle D of the ridge from which the minutiae feature was extracted).

C. Hypothesis Generation

The goal of this step is to generate a number of hypothetical alignments between minutiae sets. This is performed by finding corresponding minutiae triangles using the invariant attributes. To improve accuracy, minutiae orientation information can be used during the matching process. By way of example, minutiae orientation may be defined as the orientation of the ridge containing the feature, as shown in FIG. 1. Specifically, let T and Q correspond to two different minutiae templates. Then, triangles in T may be compared to triangles in Q using the following three constraints:

1) Similarity Consistency: This constraint tests the similarity between two minutiae triangles using their invariant features. As shown in FIG. 7, each minutiae triangle may be represented by six invariants. If the differences between corresponding pairs of invariants are all below a threshold, then the triangles are considered to match. In particular examples of the disclosed method, the thresholds used for the spatial and angular features are 0.3 and 0.5 respectively. These thresholds are relatively high in order to account for nonlinear minutiae dislocations. Many false matches are subsequently eliminated by the third criterion.

2) Planarity Consistency: This constraint tests whether matching minutiae triangles can be brought into alignment using in-plane transformations only. FIG. 8 illustrates this criterion with an example illustrating an inconsistency in the ordering of the minutiae between triangles. If the minutiae in FIG. 8 are ordered starting from the first one in each triangle and going clockwise, the ordering in the left triangle would be m₁₁m₁₂m₁₃ while the ordering in the right triangle would be m₂₁m₂₃m₂₂. An out-of-plane transformation is therefore used to align the triangles. Such inconsistencies can be fixed by changing the order of the minutiae in the left triangle (e.g., starting from m₁₂). Then, the similarity consistency between the two triangles can be tested using the new ordering. In some examples, all three possible orders are considered.

3) Minutiae Orientation Consistency: The purpose of this constraint is to test whether corresponding minutiae have similar orientations. This is performed by estimating the rigid transformation that aligns corresponding triangles and computing the orientation differences of the corresponding minutiae. If the average orientation difference is below a threshold (e.g., 30 degrees), then corresponding minutiae are considered to have similar orientations.

In a particular embodiment of the disclosed method, if all three constraints are satisfied for a given pair of minutiae triangles, then the minutiae triangles are considered to match. Given a pair of matching triangles, a rigid transformation can be computed which aligns them. These, “locally optimum”, transformations may then be used to substantiate a number of hypothetical alignment transformations between the minutiae sets. To find a “globally consistent” transform (or “global transform”), a voting scheme may be employed where each matching pair of triangles casts a weighted vote in the transformation space. The weight of a vote may be inversely proportional to the average minutiae orientation differences. To compensate for quantization errors in the transformation space, votes can also be cast to the immediate neighbors of the estimated transformation using lower weights (i.e., ⅔ of the vote cast to the estimated transformation). In some embodiments of the disclosed method, alignment transformations that receive high votes are considered for further verification.

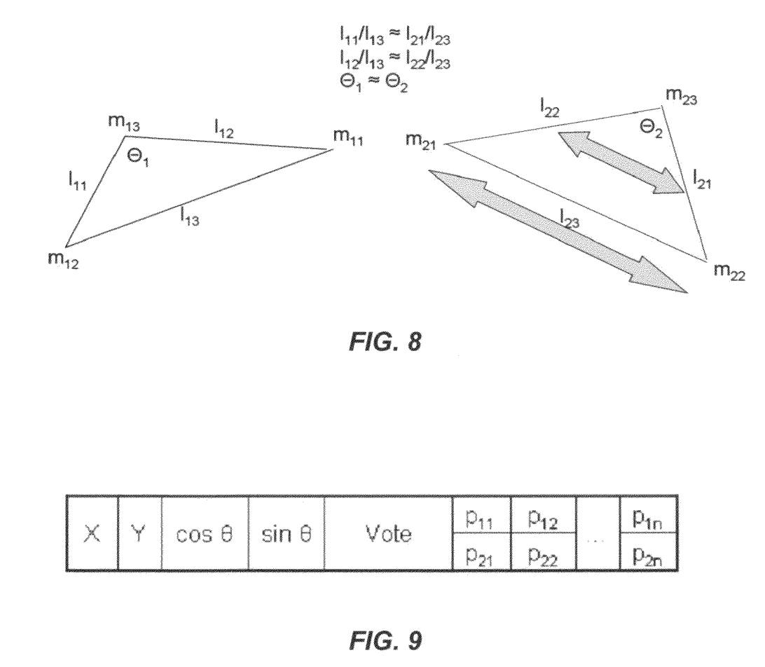

FIG. 9 shows the structure of the entries in the transformation space. Each entry holds (i) the transformation parameters (e.g., x, y, cos(θ), sin(θ)), (ii) the number of votes (Vote), and (iii) a list of corresponding minutiae that have voted for this transformation (e.g. p₁₁, p₁₂, etc.). The transformation space typically needs to be quantized coarsely enough to let the entries receive enough votes and build reasonable histograms. Since the minutiae triangles are aligned using rigid transformations, the transformation space is three-dimensional (i.e., x, y, and θ). However, since cos(θ) and sin(θ) are frequently used in calculations, this information is stored instead of the actual angle, for efficiency, in some implementations of the disclosed method.

After all the votes have been accumulated, local maxima in the transformation space are detected and considered as possible candidates for aligning the minutiae sets. The resulting set of transformations yields a set of hypotheses which are verified in the next stage.

D. Hypothesis Verification

In this stage, the minutiae templates are aligned using the hypothetical transformations in order to determine the highest number of overlapping minutiae. First, each candidate transformation is refined (i.e., re-estimated) using all matching triangles that have voted for that transformation. Unlike local transformation computations, which are typically based only on a pair of minutiae triangles, the refinement process computes globally consistent transformations by considering minutiae correspondences scattered over a diverse region of the fingerprint. Then, the quality of each hypothesis is evaluated by aligning the minutiae sets and computing the number of overlapping minutiae.

The overlap between the minutiae sets is determined by considering the differences between corresponding minutiae locations and orientation angles. The number of overlapping minutiae may be normalized to calculate a similarity score between the minutiae sets. Specifically, let t and q be the number of minutiae in the two sets respectively. If m is the number of matching minutiae, then the similarity score s is calculated as follows:

$$s = \frac{2 m}{t + q} \times 100 \qquad ( 3 )$$

The hypothesis yielding the highest number of overlapping minutiae is taken as the best hypothesis. However, other ways to compute similarity scores exist and may be used.

II. Fingerprint Matching Using Delaunay Triangulation Hierarchies

A potential issue when employing Delaunay triangulation for matching is that missing or spurious minutiae can change the triangulation locally, by introducing spurious triangles, or by eliminating important triangles. As a result, matching quality can be degraded—especially when the overlap between minutiae sets to be matched is poor.

When multiple impressions of the same fingerprint are available, more reliable decisions about the presence or quality of fingerprint features can sometimes be made by combining information from each impression. In this section, a novel matching method which employs the preceding Delaunay triangulation matching method is presented.

The novel matching method includes, in some implementations, extensions to account for missing and spurious minutiae. For example, a hierarchical matching of minutiae, such as a matching based on minutiae quality, is employed. The disclosed method involves, in some implementations, representing the super-template minutiae in terms of a hierarchy of Delaunay triangulations where every level of the hierarchy corresponds to a subset of minutiae, having certain quality only. For example, the Delaunay triangulation at the lowest level of the hierarchy may contain all minutiae, independent of quality, while the Delaunay triangulations at higher levels of the hierarchy contain minutiae of higher quality only. In one embodiment of the disclosed method, matching is performed hierarchically, starting at the top of the Delaunay hierarchy, which contains high quality minutiae only, and moving down to lower levels, effectively considering lower quality minutiae on an incremental basis. At each level, a number of hypothetical alignment transformations are computed, as described in Section I, and refined in an iterative fashion using affine transformations, such as using the method of [4].

It should be emphasized that the disclosed hierarchical matching strategy, at least in some implementations, is closely interrelated with a template synthesis approach, which is described in the next section. In particular, the template synthesis method may use the hierarchical matching method to merge the enrollment templates into a super-template, while the hierarchical matching method uses super-templates, such as those built by the template synthesis method, for fingerprint authentication. One difference between these methods is that when hierarchical matching is employed to build super-templates, the enrollment templates are compared to the current super-templates; however, when it is employed for authentication, new templates are compared to the final super-templates.

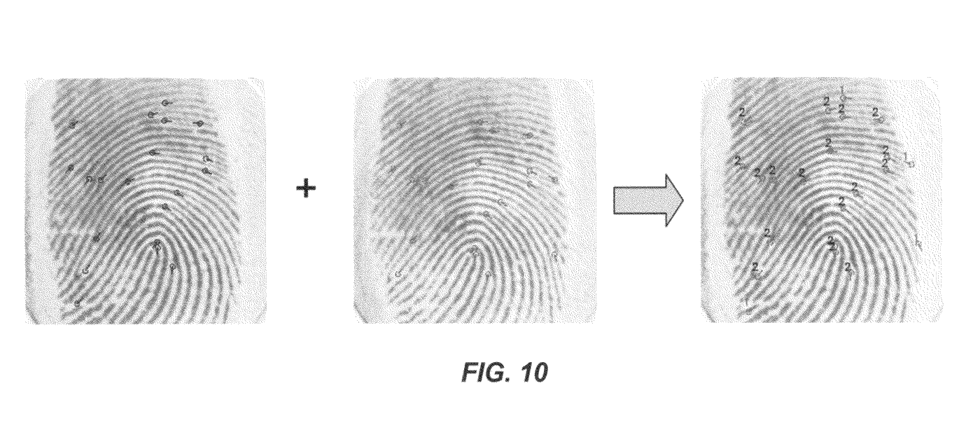

In explaining the disclosed hierarchical matching method, it is assumed that a super-template has already been built using the template synthesis method described in Section III. Although template synthesis will be described in more detail, one relevant property is that super-template minutiae may be associated with weights that characterize their quality. In one example, minutiae quality can be evaluated in different ways; here, minutiae quality is characterized by a minutiae's frequency of occurrence in a plurality of enrollment templates. FIG. 10 shows an example of a super-template which was built by merging two enrollment templates. In this case, minutiae weights have two possible values (i.e., 1 or 2), with higher weight values implying higher quality minutiae.

A. Hierarchical Delaunay Triangulation

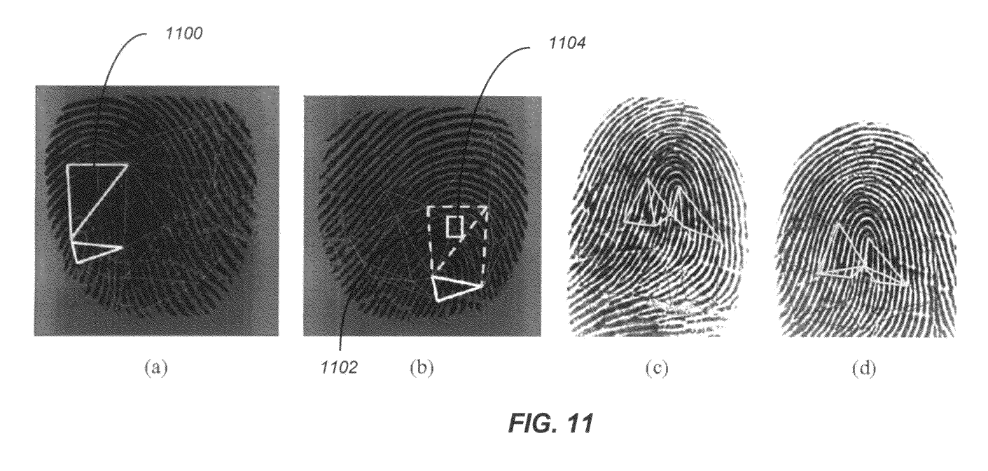

Missing and/or spurious minutiae, as well as nonlinear distortions, can affect the Delaunay triangulation, as illustrated in FIGS. 11(a)-(d). In this example, the triangles 1100, 1102 shown in FIG. 11(a) cannot be detected in FIG. 11(b) due to a spurious minutiae (e.g., shown by rectangle 1104 in FIG. 11(b)), which is the result of smudging. FIGS. 11(c) and 11(d) contain no missing minutiae; however, nonlinear dislocations between the two fingerprints, due to the elasticity of the skin, have altered the topology and shape of corresponding triangles.

Exploiting minutiae quality is useful at this point, allowing a given template to be matched to a super-template by representing the super-template minutiae hierarchically, based on their quality. As mentioned earlier, super-template minutiae are associated with weights which correspond to their frequency of occurrence in enrollment templates. The weights serve as quality measures. In general, minutiae quality is inversely proportional to the probability that a given minutiae is spurious or could not be detected. This implies that minutiae having high weights would be more likely to show up in most impressions (i.e., true minutiae) than those having lower weights (i.e., spurious minutiae). Based on this observation, matching is performed hierarchically, attempting to match high quality minutiae first, and considering lower quality minutiae on an incremental basis. This process is facilitated by representing each super-template using a Delaunay triangulation hierarchy.

Specifically, assuming that minutiae weights range from 1 to k, k minutiae groups may be formed, and their Delaunay triangulations may be organized in a hierarchy. The group at the bottom of the hierarchy may contain minutiae having weights greater or equal to one (i.e., all possible super-template minutiae, independently of their quality). A group at some level i, where 1=i=k, contains minutiae having weights greater or equal to i (i.e., lower quality minutiae are excluded when moving to higher levels). Finally, the group at the top level of the hierarchy may contain minutiae having weights equal to k (i.e., highest quality super-template minutiae).

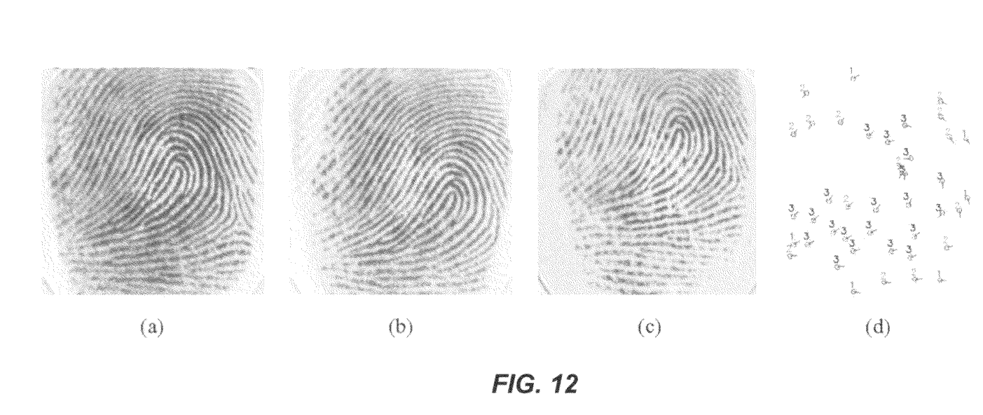

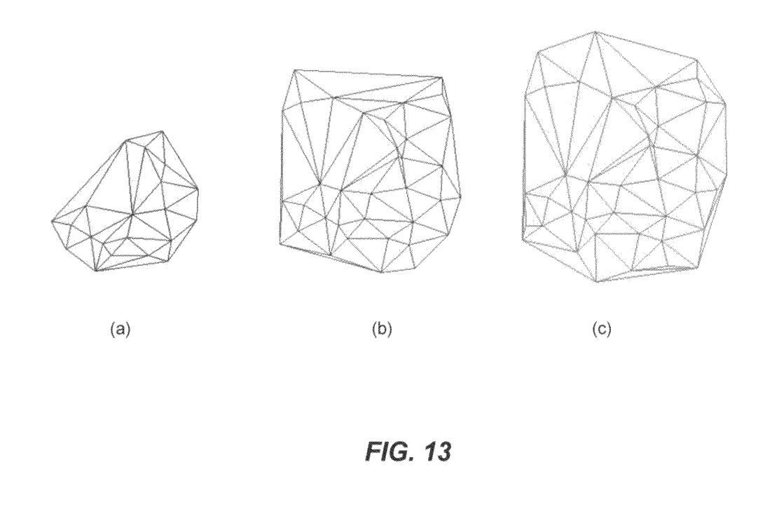

FIG. 12(d) shows an example of a super-template that may be built by merging the templates shown in FIGS. 12 (a)-(c). FIG. 13 illustrates the corresponding Delaunay triangulation hierarchy, which contains three levels in this case. In particular, FIG. 13(a) shows the Delaunay triangulation corresponding to minutiae whose weight is equal to 3. The triangulation shown in FIG. 13(b) corresponds to minutiae whose weight is equal to 2 or 3. Finally, FIG. 13(c) shows the triangulation corresponding to minutiae whose weight is equal to 1, 2, or 3 (i.e., all possible minutiae).

B. Hierarchical Matching

When comparing a candidate template (i.e., enrollment or query) to a given super-template, matching is typically performed hierarchically, starting at the top level of the hierarchy (i.e., considering highest quality minutiae), and ending at the bottom level of the hierarchy (i.e., considering all possible minutiae). Traversing the hierarchy in a top-down way is equivalent to taking lower quality minutiae into consideration on an incremental fashion. At each level, matching is performed as described in Section I. That is, matching triangles from the triangulation of the input template to triangles corresponding to the triangulation of the super-template at that level. Referring to FIG. 13, when matching a new template to a super-template, its Delaunay triangulation might have to be compared with all three triangulations in order to calculate an optimum alignment between the template and the super-template.

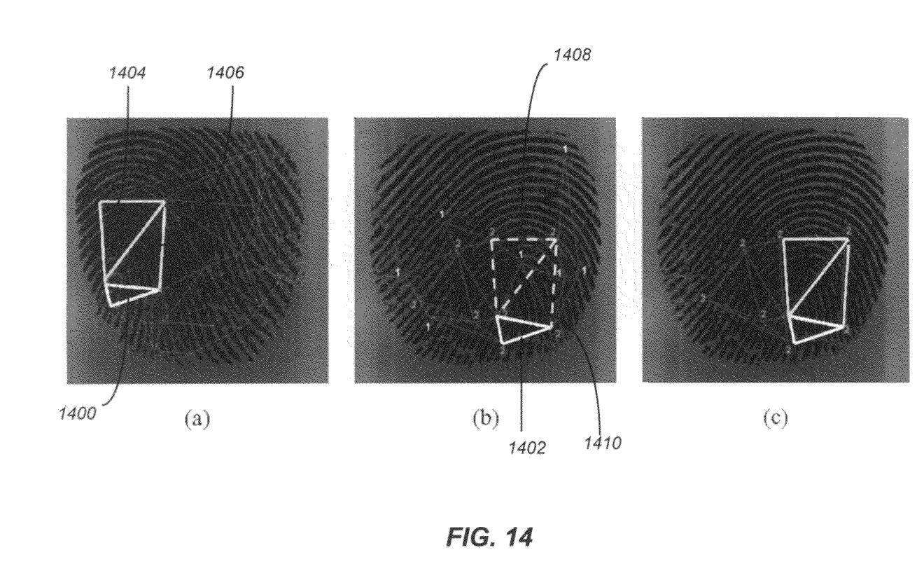

Associating quality measures (such as frequencies of occurrence) with the super-template minutiae is a particular feature of at least certain embodiments of the disclosed method, and can increase matching success by limiting the impact of low-weight (and often spurious) minutiae on the matching method. Using minutiae weights can result in low-quality minutiae being considered only at the last stages of matching. FIG. 14 shows an example illustrating the benefits of an example of the disclosed hierarchical matching method. In this example, minutiae have a weight equal to 1 or 2; therefore, the Delaunay triangulation hierarchy has two levels. Using the bottom level of the hierarchy, the triangles 1400, 1402 shown in FIGS. 14(a) and (b) can be matched, but the triangles 1404, 1406, 1408, 1410 cannot be matched. This is because the triangles 1408, 1410 in FIG. 14(b) cannot be formed due to the presence of a spurious minutiae. Using the top level of the hierarchy, however, allows the formation and matching of the triangles 1408, 1410 as shown in FIG. 14(c).

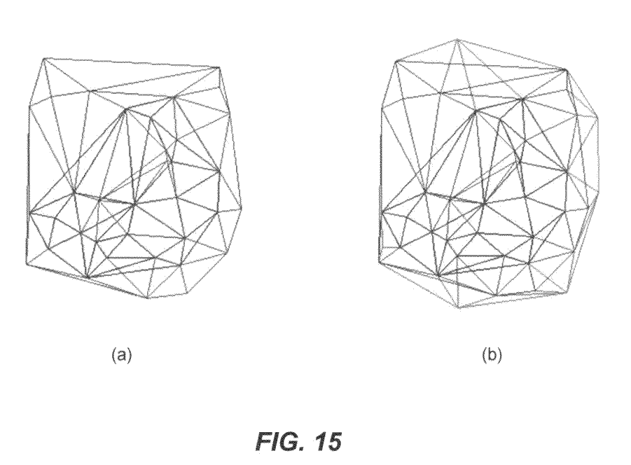

The Delaunay triangles at the i+1 level of the hierarchy are not necessarily a subset of the Delaunay triangles at the i level of the hierarchy. To improve matching results by increasing support in the transformation space, when considering the i level, a hierarchical matching method may consider not only Delanuay triangles at this level, but also Delaunay triangles at higher levels, assuming that (i) they are different from those at level i and, (ii) they have been matched successfully with the super-template in previous iterations. To illustrate this example of the disclosed method, FIG. 15(a) shows the combined triangulations of FIGS. 13(a) and 13(b), while FIG. 15(b) shows the combined triangulations of FIGS. 13(a), 13(b) and 13(c). The triangles shown in FIG. 13(b) are not all the same to the triangles shown in FIG. 15(a). The same is true for the triangles shown in FIG. 13(c) and FIG. 15(b).

Although one matching scheme has been disclosed, other matching schemes may be used, such as one that exploits minutiae quality information, instead of or in addition to the disclosed hierarchical matching method, in other ways. For example, when matching minutiae pairs, the score computed for each pair may be weighted by a factor which is proportional to the quality of the minutiae being matched (e.g., average of the minutiae weights being matched). Alternatively, low-quality minutiae may be completely removed, such as by thresholding their weights. In practice, keeping low-quality minutiae and performing the matching hierarchically has tended to produce superior results.

C. Refinement Using Affine Transformations

Due to non-linear distortions present in fingerprints, using rigid transformations to register a pair of minutiae sets at any level of the Delaunay hierarchy may not yield optimum results. Since it is typically beneficial to align the enrollment templates with the super-template as accurately as possible to avoid registration errors, the estimated alignment may be improved (i.e., based on rigid transformations) by applying affine refinements in an iterative fashion, as in [4]. The basic idea is finding additional minutiae correspondences iteratively and re-estimating the parameters of the alignment.

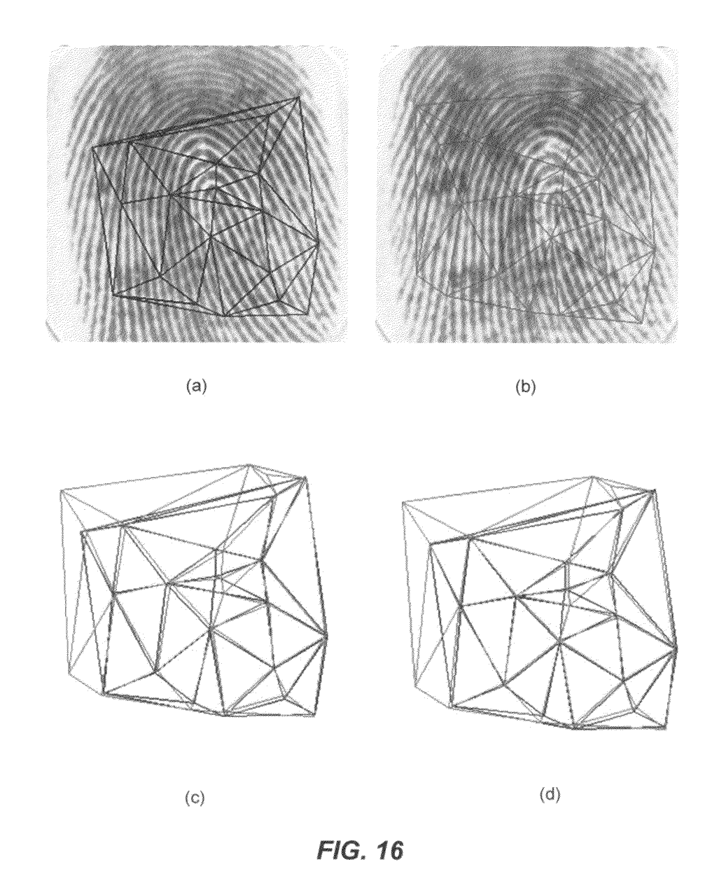

Although affine transformations cannot typically model complex, non-linear fingerprint distortions, they can still account for certain kinds of deformations such as shearing. FIG. 16 shows an example where the minutiae in FIG. 16(b) need to be registered with the minutiae in FIG. 16(a). FIG. 16(c) shows the results of registering the two sets using a rigid transformation, while FIG. 16(d) shows the results after a single affine refinement.

Affine refinements may be computed in an iterative fashion. That is, first, a set of matching minutiae pairs may be found by aligning the minutiae sets using the estimated rigid transformation. An initial affine transformation may then be computed using the matching minutiae pairs. Then, the set of matching minutiae pairs may be updated by aligning the minutiae using the estimated affine transformation. Using the updated set of matching minutiae pairs, a new affine transformation may be estimated to further improve the alignment transformation. This process may then be repeated until no more alignment improvements are possible. In some examples, subsequent iterations of the method may use more conservative affine transformation criteria to establish matching minutiae pairs (i.e., the allowed distance between matching minutiae pairs decreases in each iteration).

III. A Method of Determining a Best Match Between a Candidate Template and a Super-Template

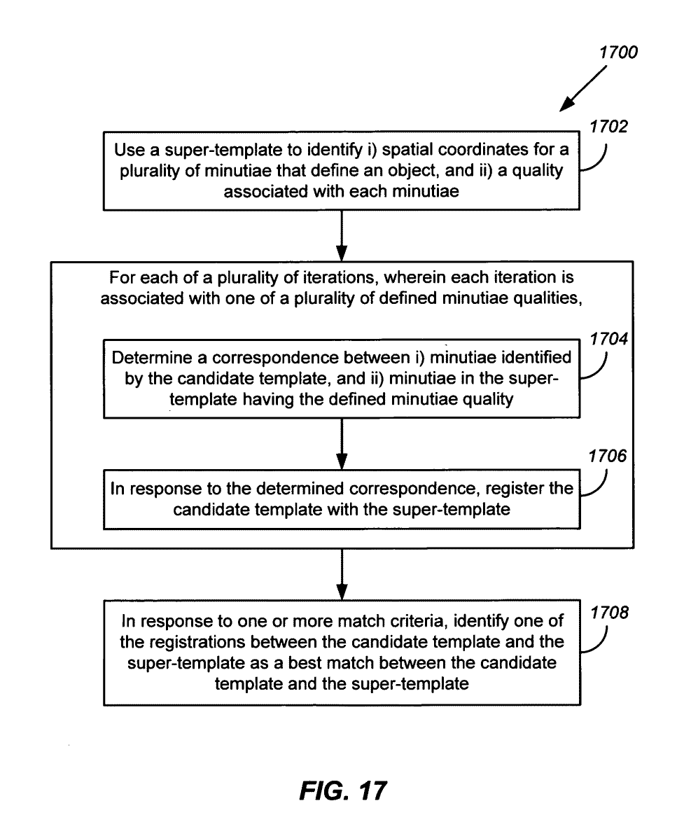

Given the preceding teachings, FIG. 17 illustrates an embodiment 1700 of a method that can be used to determine a best match between a candidate template and a super-template. The method 1700 includes the step of using the super-template to identify i) spatial coordinates for a plurality of minutiae that define an object, and ii) a quality associated with each minutiae (at block 1702). In some cases, the object may be a fingerprint. For each of a plurality of iterations, wherein each iteration is associated with one of a plurality of defined minutiae qualities, the method 1) determines a correspondence between i) minutiae identified by the candidate template, and ii) minutiae in the super-template having the defined minutiae quality (at block 1704), and 2) in response to the determined correspondence, registers the candidate template with the super-template (at block 1706). In response to one or more match criteria, one of the registrations between the candidate template and the super-template is identified as a best match between the candidate template and the super-template (at block 1708). In some cases, the match criteria may define a “best match” as a match that results in alignment of a greatest number of minutiae in two templates.

In some implementations of the method 1700, and for at least one of the “iterations”, the correspondence between i) the minutiae identified by the candidate template and ii) the minutiae in the super-template having the defined minutiae quality are determined by comparing a) minutiae triangles formed from the minutiae identified by the candidate template to b) minutiae triangles formed from the minutiae in the super-template having the defined minutiae quality. In some cases, the minutiae triangles are identified from respective Delaunay triangulations of i) the minutiae identified by the candidate template, and ii) the minutiae in the super-template having the defined minutiae quality.

In some implementations of the method 1700, and for at least one of the “iterations”, the correspondence between i) the minutiae identified by the candidate template, and ii) the set of minutiae in the super-template having the defined minutiae quality are determined as follows. First, a correspondence is determined between i) minutiae triangles identified by the candidate template and ii) minutiae triangles identified by the minutiae in the super-template (which minutiae have the defined minutiae quality for the current iteration). Next, local minutiae transforms supported by corresponding minutiae triangles are computed. For each local transform supported by corresponding pairs of minutiae triangles, a global minutiae transform supported by the multiple corresponding pairs of minutiae triangles is computed. In such an implementation, the candidate template may be registered with the super-template in response to a minutiae transform that fits a greatest number of minutiae in the candidate template to the minutiae in the super-template. In some cases, the step of determining a correspondence between i) the pairs of minutiae triangles identified by the candidate template and ii) the pairs of minutiae triangles identified by the minutiae in the super-template having the defined minutiae quality further comprises determining a correspondence of minutiae orientation between i) the pairs of minutiae triangles identified by the candidate template and ii) the pairs of minutiae triangles identified by the minutiae in the super-template having the defined minutiae quality rating. In the case of fingerprints, and by way of example, the minutiae orientations may be orientations of fingerprint ridges.

In still other implementations of the method 1700, the “iterations” are performed hierarchically, beginning with an iteration encompassing a higher minutiae quality and ending with an iteration encompassing a lower minutiae quality. Then, and for at least one of the iterations, the correspondence between i) the minutiae identified by the candidate template and ii) the minutiae in the super-template having the defined minutiae quality are determined by comparing a) minutiae triangles formed from the minutiae identified by the candidate template to both of b) minutiae triangles formed from the minutiae in the super-template having the defined minutiae quality rating and c) minutiae triangles of the candidate template and the super-template that were registered in prior iterations.

When registering a candidate template with a super-template, the method 1700 comprises, in some implementations, transforming spatial coordinates of the minutiae of the candidate template, in response to the determined correspondence of minutiae. In some cases, the transformations comprise affine transformations.

In one example, the minutiae qualities include frequencies of occurrence (e.g., counts) of the minutiae in a plurality of enrollment templates of the object. In another example, the minutiae qualities include quality measures based on, for example, a quality map for an image.

In some cases, each iteration of the method 1700 is associated with a defined minutiae quality that captures all minutiae having a quality ‘x,’ where ‘x’ differs for each iteration.

The method 1700 has various applications. For example, in some cases, the registration identified as the “best match” is used to merge at least some of the minutiae identified by the candidate template into the super-template. At the same time (or thereabout), the minutiae qualities of the minutiae in the super-template are updated by combining minutiae qualities of corresponding minutiae in the candidate template and the super-template.

In other applications, the method 1700 further includes authenticating an object defined by the candidate template when the registration identified as the best match exceeds a match threshold.

IV. Fingerprint Super-Template Synthesis

In this section, a template synthesis method is described. The template synthesis method combines a number of enrollment templates into a super-template, in order to, for example, increase finger coverage area, restore missing minutiae, and/or eliminate spurious minutiae. The disclosed template synthesis method includes a hierarchical matching strategy, such as that described in the previous sections, for registering (or aligning) and merging the enrollment templates with the super-template. First, the super-template is initialized by choosing one of the enrollment templates to be merged. Then, the remaining enrollment templates are aligned and merged with the current super-template sequentially. During this process, new minutiae can be added to the super-template. Super-template minutiae are associated with several attributes including their spatial coordinates and the number of times they appear in the enrollment templates (i.e., frequency of occurrence). This information can serve as a quality measure. In the rest of this discussion, the enrollment template that is chosen to initialize the super-template is referred to as the “prime” (or first) enrollment template. The order of merging the rest (or next ones) of the enrollment templates with the current super-template is determined, in some examples, based on their similarity with the current super-template. Specifically given a number of enrollment templates, the super-template is built as follows:

1) Set t=1 and select the highest quality enrollment template as the prime template(T_{P}) and initialize the super-template (i.e., S₁=Tₚ). Set all of the minutiae frequencies in the initial super-template to one.

2) Compute the similarity of each of the remaining enrollment templates with the current super-template using hierarchical matching. Select the template Tₚ being most similar to the current super-template.

3) If Tₙ is “similar” enough with the current super-template, then merge it with the current super-template: Sₜ₊₁=Sₜ∪Tₙ.

4) If there are more enrollment templates left for merging, then set t=t+1 and go to step 2; otherwise exit.

A. Prime Selection and Order of Merging

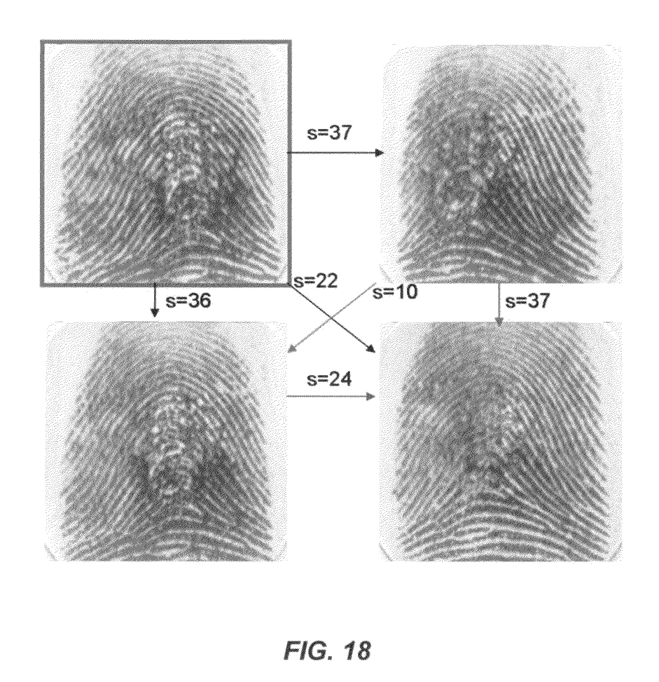

Selection of the prime template can have an impact on the performance of the synthesis method. For example, selecting a low-quality template can cause subsequent registration operations to fail. Two different approaches are described. The first approach, which is similar to the method in [5], compares each enrollment template with all others and computes an average similarity score for each enrollment template. The enrollment template with the highest average similarity score is selected as the prime template. However, this implementation is not always effective since it does not take into consideration the quality of the fingerprint image. An example illustrating this issue is shown in FIG. 18. Using the above procedure leads to choosing the fingerprint shown in FIG. 18(c) as the prime; however, the fingerprint shown in FIG. 18(d) is visually a better candidate.

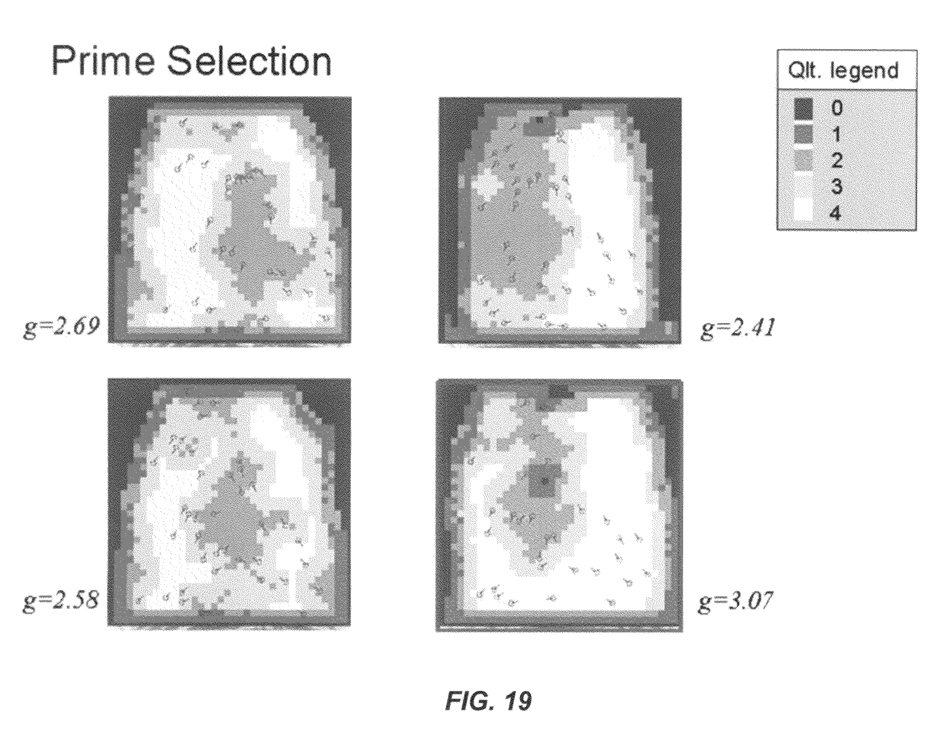

The second approach uses a global quality measure to select the prime template. In this case, a quality index is associated with the minutiae of each template, and the template having the highest overall quality is selected. To associate a quality index with minutiae, NIST's fingerprint processing software [25], for example, may be used to compute a quality map for a fingerprint image. The software computes a block-wise (i.e., 8×8 block) quality index map, where the quality index is, for example, an integer in the range of zero to four (i.e., 0 represents the lowest quality index, and 4 represents the highest quality index). To compute a global quality measure for a given fingerprint image, its minutiae are extracted and assigned quality indices by overlaying them on the quality map (i.e., see FIG. 19). Lighter areas in the FIG. 19 quality indices correspond to higher quality regions. The average of quality indices over all minutiae provides a global quality measure of the underlying fingerprint image. Using this measure, the lower-right fingerprint is selected as prime.

Once the prime has been selected, the order of merging the remaining templates with the current super-template is determined. Although it is possible to go on with the same idea, in practice, similarity measures often provide superior results. This is because once the prime has been selected, the reliability of matching operations increases using similarity measures rather than quality indices. Therefore, the order of merging may be determined by computing the similarity of the remaining enrollment templates with the current super-template and choosing the one being most similar to the current super-template.

The presence of very low quality enrollment templates could actually hamper the construction of the super-templates. The reason is that minutiae templates corresponding to low quality images might not be aligned accurately with the current super-template, potentially increasing spurious minutiae. To deal with this issue, not every enrollment template need be “forced” to be merged with the current super-template. In contrast, enrollment templates can be merged only when they are similar enough with the current super-template. A hysteresis-based decision making approach may be used to implement this method. Specifically, if an enrollment template has a similarity score higher than a threshold s₁, the merging takes place. If its similarity score is less than some other threshold s₂, where s₂<s₁, then no merging takes place. However, if its similarity score is between s₂ and s₁, similarity scores computed for this enrollment template in previous iterations are reviewed (i.e., assuming an earlier version of the current super-template). If one of these scores was more than s₁, then it is merged with the current super-template; otherwise, no merging takes place. In particular examples, s₁ is set to 20, and s₂ is set to 10.

B. Super-Template Updating

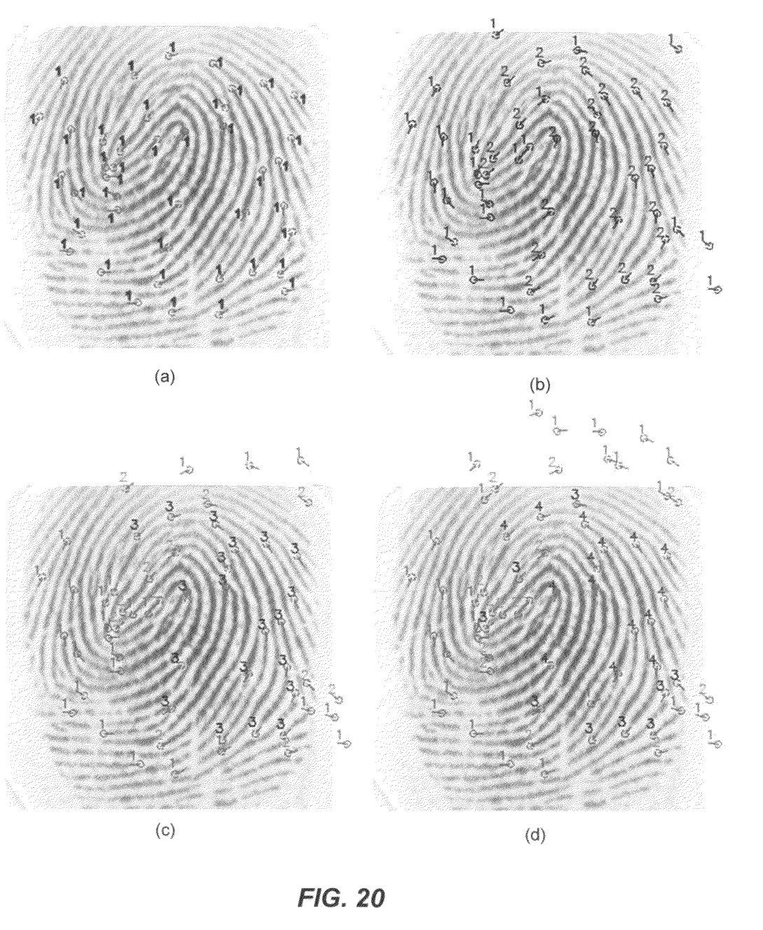

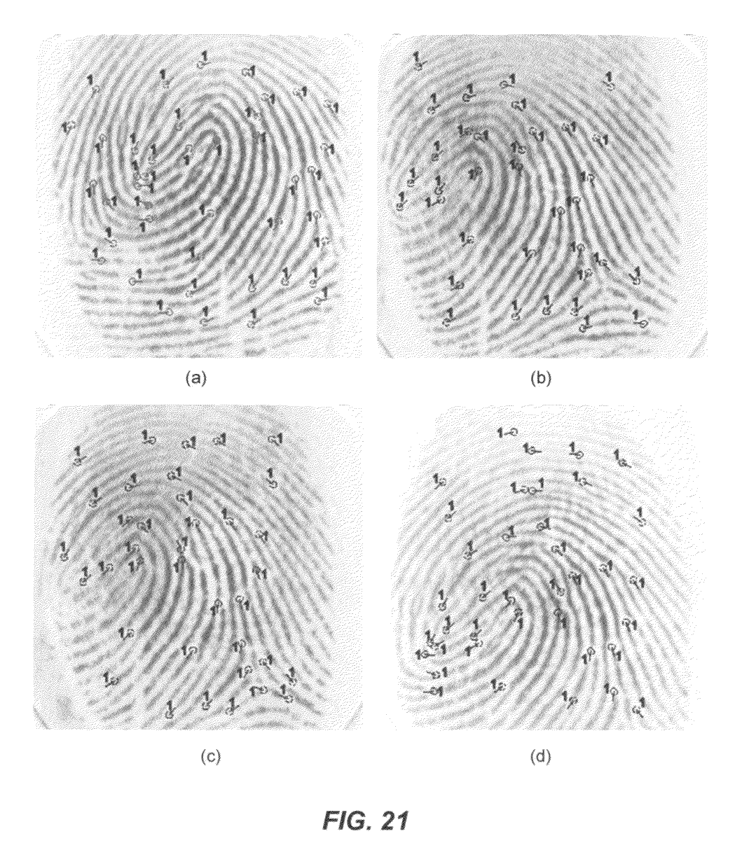

When an enrollment template is merged with the current super-template, then all of the minutiae in the super-template that have corresponding minutiae in the enrollment template may have their weights increased by one. Moreover, minutiae in the enrollment template that do not have correspondences in the super-template are added to the super-template and their weights are set to one. FIG. 20 illustrates how the super-template minutiae are updated using the enrollment templates shown in FIG. 21. In particular, FIG. 20(a) shows the prime template used to initialize the super-template (i.e., same as FIG. 21(a)), while FIGS. 20(b)-(d) show how the current super-template is updated. As new templates are merged with the current super-template, the area of the super-template grows, addressing the small area problem. Moreover, the weights of stable minutiae increase, reflecting their frequency of occurrence in the enrollment templates, addressing the spurious minutiae problem.

V. A Method of Synthesizing a Super-Template for an Object

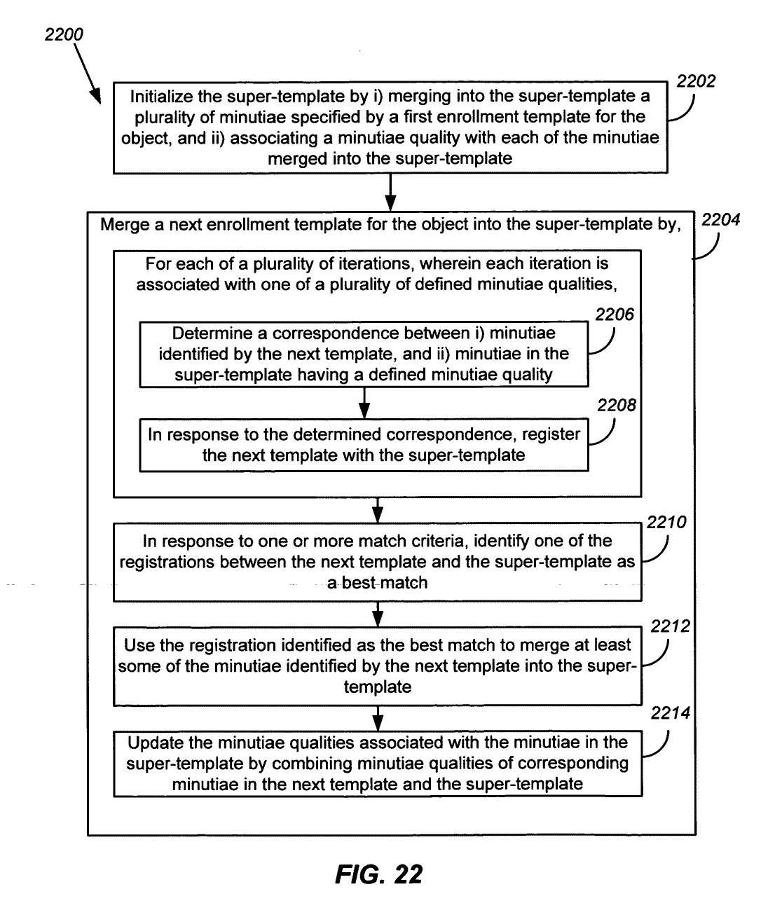

Given the preceding teachings, FIG. 22 illustrates a method 2200 of synthesizing a super-template for an object such as a fingerprint. The method 2200 includes initializing the super-template by i) merging into the super-template a plurality of minutiae specified by a first enrollment template for the object, and ii) associating a minutiae quality with each of the minutiae merged into the super-template (at block 2202). A next enrollment template for the object is then merged into the super-template (at block 2204). The next enrollment template is merged by, for each of a plurality of iterations, wherein each iteration is associated with one of a plurality of defined minutiae quality ratings, A) determining a correspondence between i) minutiae identified by the next template, and ii) minutiae in the super-template having a defined minutiae quality rating (at block 2206); and B) in response to the determined correspondence, registering the next template with the super-template (at block 2208). Finally, and in response to one or more match criteria, one of the registrations between the next template and the super-template is identified as a “best match” (at block 2210). This “best match” registration is then used to merge at least some of the minutiae identified by the next template into the super-template (at block 2212). Also, the minutiae qualities associated with the minutiae in the super-template are updated by combining minutiae qualities of corresponding minutiae in the next template and the super-template (at block 2214).

In some embodiments of the method 2200, the first enrollment template is selected from a plurality of enrollment templates based on a quality of each enrollment template. The next enrollment template is then selected from amongst a plurality of enrollment templates based on similarities of each enrollment template to the current super-template. Alternately, the first enrollment template could be selected from the plurality of enrollment templates based on an average similarity of each enrollment template to the plurality of enrollment templates, and/or the next enrollment template could be selected from the plurality of enrollment templates based on a quality of each enrollment template.

When assessing the similarities of each enrollment template to the super-template or the plurality of enrollment templates, the similarities may be re-assessed after each of the “iterations” performed by the method 2200.

In some cases, the quality of a particular enrollment template may be based on an average quality of its minutiae.

In still further embodiments of the method 2200, each of the plurality of enrollment templates that has a similarity with the super-template above a first threshold is merged with the super-template. Then, enrollment templates that were determined, at prior iterations, to have a similarity with the super-template between a first threshold and a second threshold are merged with the super-template. Merger of enrollment templates that were determined to have a similarity with the super-template below the second threshold is then foregone (i.e., this last set of enrollment templates are not merged with the super-template).

VI. Fingerprint Authentication/Verification

During fingerprint authentication, the identity of a new template is verified by matching it with the super-template of the object (or subject) whose identity is claimed. Although any minutiae-based matching method could be used for verification, one method that can be used is the same hierarchical matching strategy disclosed above (with minor modifications and stricter parameter settings to better account for imposters). The stricter parameter settings will often be helpful because, unlike merging enrollment templates that are known to come from the same object (or finger), objects being authenticated may belong to objects that do not match the super-template for which an authentication attempt is being made. Specifically, when matching a new template to a given super-template for verification purposes, the given super-template is not updated (although one can envision incremental learning schemes where super-templates are updated over time). The proposed approach is well suited for on-line learning. Second, although affine refinements have shown to improve merging results, they have a tendency to increase imposter scores during authentication. This is because the candidate (or query) template and the super-template might not come from the same finger. Therefore, in at least some implementations of the disclosed method, affine refinements are not made during authentication.

VII. Examples of Computer Systems for Executing the Disclosed Methods

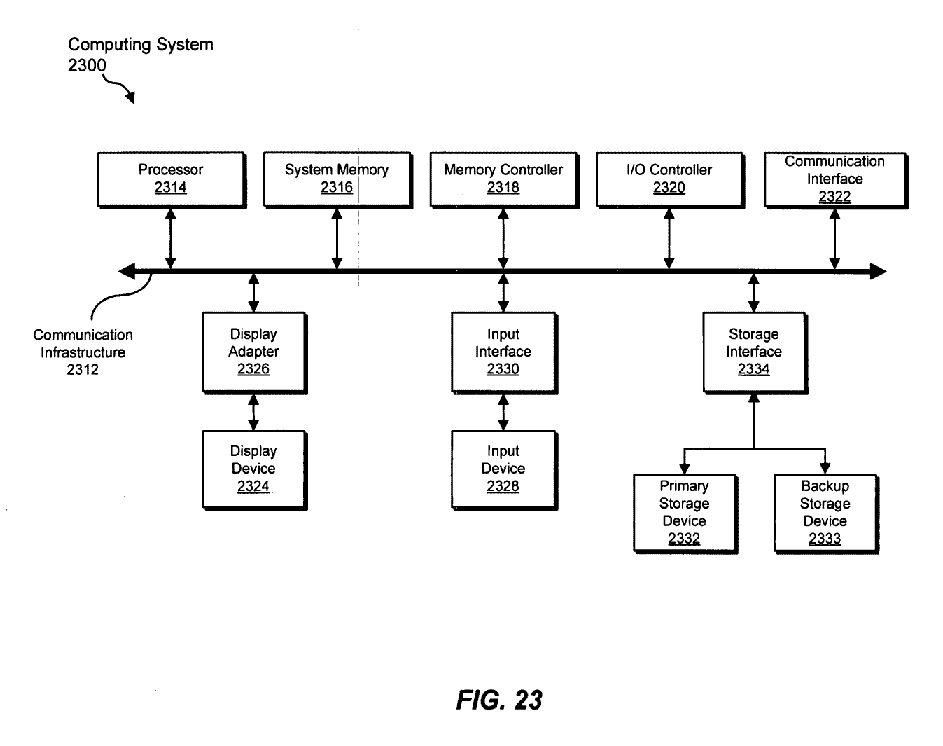

FIG. 23 is a block diagram of an exemplary computing system 2300 capable of implementing one or more of the methods described and/or illustrated herein. Computing system 2300 broadly represents any single or multi-processor computing device or system capable of executing computer-readable instructions. Examples of computing system 2300 include, without limitation, workstations, laptops, client-side terminals, servers, distributed computing systems, handheld devices, or any other computing system or device that might perform a matching or authentication operation. In its most basic configuration, computing system 2300 may comprise at least one processor 2314 and a system memory 2316.

Processor 2314 generally represents any type or form of processing unit capable of processing data or interpreting and executing instructions. In certain embodiments, processor 2314 may receive instructions from a software application or module. These instructions may cause processor 2314 to perform the functions of one or more of the exemplary embodiments described and/or illustrated herein. For example, processor 2314 may perform and/or be a means for performing, either alone or in combination with other elements, one or more of the identifying, transmitting, receiving, determining, selecting, and using steps described herein. Processor 2314 may also perform and/or be a means for performing any other steps, methods, or processes described and/or illustrated herein.

System memory 2316 generally represents any type or form of volatile or non-volatile storage device or medium capable of storing data and/or other computer-readable instructions. Examples of system memory 2316 include, without limitation, random access memory (RAM), read only memory (ROM), flash memory, or any other suitable memory device. Although not required, in certain embodiments computing system 2300 may comprise both a volatile memory unit (such as, for example, system memory 2316) and a non-volatile storage device (such as, for example, primary storage device 2332, as described in detail below).

In certain embodiments, exemplary computing system 2300 may also comprise one or more components or elements in addition to processor 2314 and system memory 2316. For example, as illustrated in FIG. 23, computing system 2300 may comprise a memory controller 2318, an Input/Output (I/O) controller 2320, and a communication interface 2322, each of which may be interconnected via a communication infrastructure 2312. Communication infrastructure 2312 generally represents any type or form of infrastructure capable of facilitating communication between one or more components of a computing device. Examples of communication infrastructure 2312 include, without limitation, a communication bus (such as an ISA, PCI, PCIe, or similar bus) and a network.

Memory controller 2318 generally represents any type or form of device capable of handling memory or data or controlling communication between one or more components of computing system 2300. For example, in certain embodiments memory controller 2318 may control communication between processor 2314, system memory 2316, and I/O controller 2320 via communication infrastructure 2312. In certain embodiments, memory controller may perform and/or be a means for performing, either alone or in combination with other elements, one or more of the steps or features described and/or illustrated herein, such as identifying, transmitting, receiving, determining, selecting, and using.

I/O controller 2320 generally represents any type or form of module capable of coordinating and/or controlling the input and output functions of a computing device. For example, in certain embodiments I/O controller may control or facilitate transfer of data between one or more elements of computing system 2300, such as processor 2314, system memory 2316, communication interface 2322, display adapter 2326, input interface 2330, and storage interface 2334. I/O controller 2320 may be used, for example, to perform and/or be a means for performing, either alone or in combination with other elements, one or more of the identifying, transmitting, receiving, determining, selecting, and using steps described herein. I/O controller 2320 may also be used to perform and/or be a means for performing other steps and features set forth in the instant disclosure.

Communication interface 2322 broadly represents any type or form of communication device or adapter capable of facilitating communication between exemplary computing system 2300 and one or more additional devices. For example, in certain embodiments, communication interface 2322 may facilitate communication between computing system 2300 and a private or public network comprising additional computing systems. Examples of communication interface 2322 include, without limitation, a wired network interface (such as a network interface card), a wireless network interface (such as a wireless network interface card), a modem, and any other suitable interface. In at least one embodiment, communication interface 2322 may provide a direct connection to a remote server via a direct link to a network, such as the Internet. Communication interface 2322 may also indirectly provide such a connection through, for example, a local area network (such as an Ethernet network), a personal area network, a telephone or cable network, a cellular telephone connection, a satellite data connection, or any other suitable connection.

In certain embodiments, communication interface 2322 may also represent a host adapter configured to facilitate communication between computing system 2300 and one or more additional network or storage devices via an external bus or communications channel. Examples of host adapters include, without limitation, SCSI host adapters, USB host adapters, IEEE 23234 host adapters, SATA and eSATA host adapters, ATA and PATA host adapters, Fibre Channel interface adapters, Ethernet adapters, or the like. Communication interface 2322 may also allow computing system 2300 to engage in distributed or remote computing. For example, communication interface 2322 may receive instructions from a remote device or send instructions to a remote device for execution. In certain embodiments, communication interface 2322 may perform and/or be a means for performing, either alone or in combination with other elements, one or more of the identifying, transmitting, receiving, determining, selecting, and using steps disclosed herein. Communication interface 2322 may also be used to perform and/or be a means for performing other steps and features set forth in the instant disclosure.

As illustrated in FIG. 23, computing system 2300 may also comprise at least one display device 2324 coupled to communication infrastructure 2312 via a display adapter 2326. Display device 2324 generally represents any type or form of device capable of visually displaying information forwarded by display adapter 2326. Similarly, display adapter 2326 generally represents any type or form of device configured to forward graphics, text, and other data from communication infrastructure 2312 (or from a frame buffer, as known in the art) for display on display device 2324.

As illustrated in FIG. 23, exemplary computing system 2300 may also comprise at least one input device 2328 coupled to communication infrastructure 2312 via an input interface 2330. Input device 2328 generally represents any type or form of input device capable of providing input, either computer or human generated, to exemplary computing system 2300. Examples of input device 2328 include, without limitation, a keyboard, a pointing device, a speech recognition device, or any other input device. In at least one embodiment, input device 2328 may perform and/or be a means for performing, either alone or in combination with other elements, one or more of the identifying, transmitting, receiving, determining, selecting, and using steps disclosed herein. Input device 2328 may also be used to perform and/or be a means for performing other steps and features set forth in the instant disclosure.

As illustrated in FIG. 23, exemplary computing system 2300 may also comprise a primary storage device 2332 and a backup storage device 2333 coupled to communication infrastructure 2312 via a storage interface 2334. Storage devices 2332 and 2333 generally represent any type or form of storage device or medium capable of storing data and/or other computer-readable instructions. For example, storage devices 2332 and 2333 may be a magnetic disk drive (e.g., a so-called hard drive), a floppy disk drive, a magnetic tape drive, an optical disk drive, a flash drive, or the like. Storage interface 2334 generally represents any type or form of interface or device for transferring data between storage devices 2332 and 2333 and other components of computing system 2300. In some cases, the storage devices 2332 and 2333 may store a fingerprint database.

In certain embodiments, storage devices 2332 and 2333 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 2332 and 2333 may also comprise other similar structures or devices for allowing computer software, data, or other computer-readable instructions to be loaded into computing system 2300. For example, storage devices 2332 and 2333 may be configured to read and write software, data, or other computer-readable information. Storage devices 2332 and 2333 may also be a part of computing system 2300 or may be a separate device accessed through other interface systems.

In certain embodiments, the exemplary file systems disclosed herein may be stored on primary storage device 2332, while the exemplary file-system backups disclosed herein may be stored on backup storage device 2333. Storage devices 2332 and 2333 may also be used, for example, to perform and/or be a means for performing, either alone or in combination with other elements, one or more of the identifying, transmitting, receiving, determining, selecting, and using steps disclosed herein. Storage devices 2332 and 2333 may also be used to perform and/or be a means for performing other steps and features set forth in the instant disclosure.

Many other devices or subsystems may be connected to computing system 2300. Conversely, all of the components and devices illustrated in FIG. 23 need not be present to practice the methods described and/or illustrated herein. The devices and subsystems referenced above may also be interconnected in different ways from that shown in FIG. 23. Computing system 2300 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The phrase “computer-readable medium” generally refers to any form of device, carrier, or medium capable of storing or carrying computer-readable instructions. Examples of computer-readable media include, without limitation, transmission-type media, such as carrier waves, and physical media, such as magnetic-storage media (e.g., hard disk drives and floppy disks), optical-storage media (e.g., CD- or DVD-ROMs), electronic-storage media (e.g., solid-state drives and flash media), and other distribution systems.

The computer-readable medium containing the computer program may be loaded into computing system 2300. All or a portion of the computer program stored on the computer-readable medium may then be stored in system memory 2316 and/or various portions of storage devices 2332 and 2333. When executed by processor 2314, a computer program loaded into computing system 2300 may cause processor 2314 to perform and/or be a means for performing the functions of one or more of the exemplary embodiments described and/or illustrated herein. Additionally or alternatively, one or more of the exemplary embodiments described and/or illustrated herein may be implemented in firmware and/or hardware. For example, computing system 2300 may be configured as an application specific integrated circuit (ASIC) adapted to implement one or more of the exemplary embodiments disclosed herein.

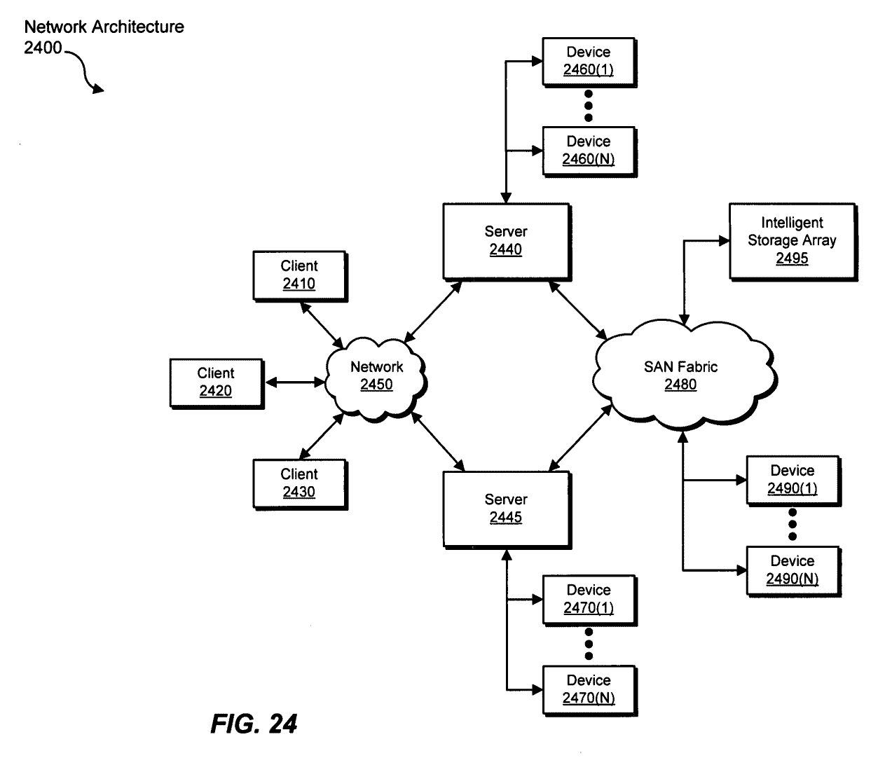

FIG. 24 is a block diagram of an exemplary network architecture 2400 in which client systems 2410, 2420, and 2430 and servers 2440 and 2445 may be coupled to a network 2450. Client systems 2410, 2420, and 2430 generally represent any type or form of computing device or system, such as exemplary computing system 2300 in FIG. 23. Similarly, servers 2440 and 2445 generally represent computing devices or systems, such as application servers or database servers, configured to provide various database services and/or to run certain software applications. Network 2450 generally represents any telecommunication or computer network; including, for example, an intranet, a wide area network (WAN), a local area network (LAN), a personal area network (PAN), or the Internet.

As illustrated in FIG. 24, one or more storage devices 2460(1)-(N) may be directly attached to server 2440. Similarly, one or more storage devices 2470(1)-(N) may be directly attached to server 2445. Storage devices 2460(1)-(N) and storage devices 2470(1)-(N) generally represent any type or form of storage device or medium capable of storing data and/or other computer-readable instructions. In certain embodiments, storage devices 2460(1)-(N) and storage devices 2470(1)-(N) may represent network-attached storage (NAS) devices configured to communicate with servers 2440 and 2445 using various protocols, such as NFS, SMB, or CIFS.

Servers 2440 and 2445 may also be connected to a storage area network (SAN) fabric 2480. SAN fabric 2480 generally represents any type or form of computer network or architecture capable of facilitating communication between a plurality of storage devices. SAN fabric 2480 may facilitate communication between servers 2440 and 2445 and a plurality of storage devices 24230(1)-(N) and/or an intelligent storage array 24235. SAN fabric 2480 may also facilitate, via network 2450 and servers 2440 and 2445, communication between client systems 2410, 2420, and 2430 and storage devices 24230(1)-(N) and/or intelligent storage array 24235 in such a manner that devices 24230(1)-(N) and array 24235 appear as locally attached devices to client systems 2410, 2420, and 2430. As with storage devices 2460(1)-(N) and storage devices 2470(1)-(N), storage devices 24230(1)-(N) and intelligent storage array 24235 generally represent any type or form of storage device or medium capable of storing data and/or other computer-readable instructions.

In certain embodiments, and with reference to exemplary computing system 2300 of FIG. 23, a communication interface, such as communication interface 2322 in FIG. 23, may be used to provide connectivity between each client system 2410, 2420, and 2430 and network 2450. Client systems 2410, 2420, and 2430 may be able to access information on server 2440 or 2445 using, for example, a web browser or other client software. Such software may allow client systems 2410, 2420, and 2430 to access data hosted by server 2440, server 2445, storage devices 2460(1)-(N), storage devices 2470(1)-(N), storage devices 24230(1)-(N), or intelligent storage array 24235. Although FIG. 24 depicts the use of a network (such as the Internet) for exchanging data, the embodiments described and/or illustrated herein are not limited to the Internet or any particular network-based environment.

In at least one embodiment, all or a portion of one or more of the exemplary methods disclosed herein may be encoded as a computer program and loaded onto and executed by server 2440, server 2445, storage devices 2460(1)-(N), storage devices 2470(1)-(N), storage devices 24230(1)-(N), intelligent storage array 24235, or any combination thereof. All or a portion of one or more of the exemplary methods disclosed herein may also be encoded as a computer program, stored in server 2440, run by server 2445, and distributed to client systems 2410, 2420, and 2430 over network 2450. Accordingly, network architecture 2400 may perform and/or be a means for performing, either alone or in combination with other elements, one or more of the identifying, transmitting, receiving, determining, selecting, and using steps disclosed herein. Network architecture 2400 may also be used to perform and/or be a means for performing other steps and features set forth in the instant disclosure.

As detailed above, computing system 2300 and/or one or more of the components of network architecture 2400 may perform and/or be a means for performing, either alone or in combination with other elements, one or more steps of the exemplary methods described and/or illustrated herein.

VIII. Example Results and Comparisons

In this section, example results are reported to illustrate the performance of the disclosed template synthesis and matching approach, as well as to compare it with other approaches. For minutiae extraction, Verifinger [26], which outputs both the coordinates and orientation of detected minutiae, was used. The right-side of FIG. 2 shows a typical output of the Verifinger software.

A. Database

In choosing a database for the disclosed examples, several public databases from the Fingerprint Verification Competition (i.e., FVC2000, FVC2002, and FVC2004) were considered. The objective in (or criteria for) choosing a database was to choose a database containing multiple impressions from each finger (e.g., more than six), small coverage area, and low quality fingerprint images. Synthetically generated databases were excluded from consideration. FVC2000 [27] contains four databases; among them, Db1 seemed to satisfy the stated criteria best (i.e., see details below). According to the FVC2000 competition results, Db3 was the hardest database, however, fingerprint coverage area was much larger compared to Db1. FVC2002 contains four databases too; among them, Db3 satisfied the criteria best, however, competition results on this database were better overall than on FVC2000 Db1. Considering the FVC2004 databases, Db3 satisfied the criteria, however, this database was obtained using a thermal sensor. Based on these observations, FVC2000 Db1 was determined to be the most appropriate database to be used for the example presented in this section of the disclosure. To obtain statistically significant results, cross-validation was used, as explained in Section VII-B.

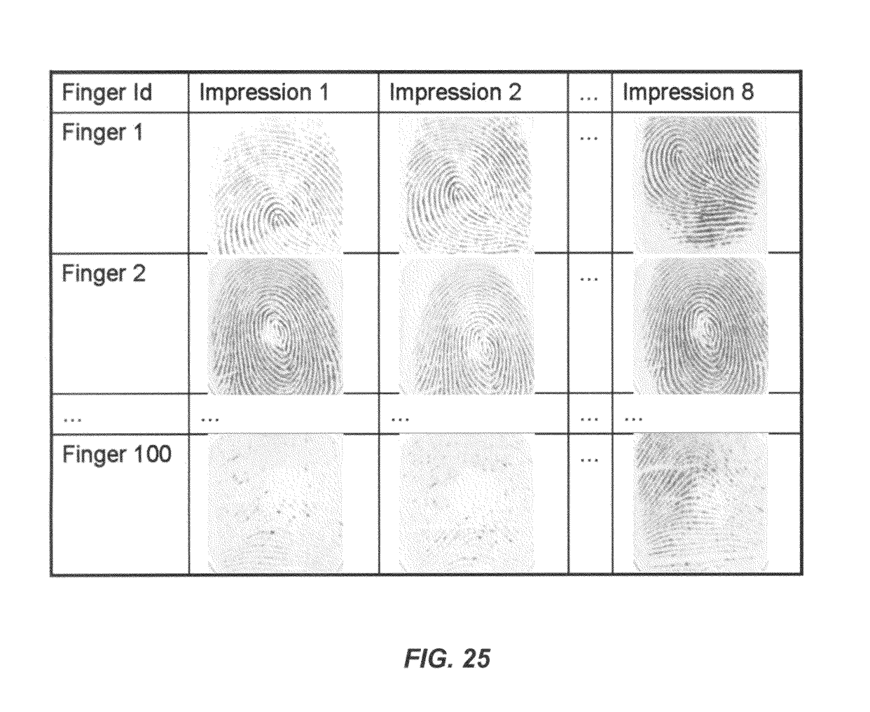

FVS2000 Db1 was created using a low cost small area optical scanner called Secure Desktop Scanner by KeyTronic. It contains a total of 800 300×300 images composed of 8 different impressions from 100 different fingers. It corresponds to a typical, small area, low-quality database. Fingerprint images were captured from untrained people in two different sessions, and no efforts were made to assure a minimum acquisition quality. The presence of cores and deltas is not guaranteed, since no attention was paid on checking the correct finger centering. Also, the sensor platens were not systematically cleaned. FIG. 25 shows several representative samples from this database.

B. Examples

In the examples discussed below, three different approaches were studied: (i) Score Level Fusion (SLF), (ii) Template Selection (T_SEL), and (iii) Template Synthesis (T_SYN). The T_SYN approach is a novel approach according to an embodiment of the present disclosure. In the case of SLF, multiple enrollment templates were stored in the database for each user. To verify a new (i.e., query) template, the similarity of a template with each of the enrollment templates of the user whose identity was claimed was computed, and the maximum matching score was taken. The average matching score, which is known to work well in practice, was also considered. However, it did not work as well as the maximum score. In the case of T_SEL, only one of the enrollment templates was chosen to represent each user. The prime selection methodology described in Section IV-A was used to select a representative enrollment template for each user. In both approaches, the matching method described in Section II was used.

For the examples, the database was randomly divided into two partitions, keeping N impressions in the first partition and the rest in the second partition. The first partition was used to create the enrollment database, and the second partition was used for testing. To show the effect of choosing a different number of enrollment impressions, examples were conducted using N=2, 3, 4 and 5. Since randomness is involved in the selection of the enrollment and test impressions, each experiment was repeated 30 times and average performance was reported.

For error rate estimation, one sample from each finger in the test set was randomly picked and compared against the enrollment data of all other fingers, yielding a total of 9900 imposter scores. The number of genuine scores varied, depending on the number of enrollment impressions. Using 2, 3, 4, and 5 impressions for enrollment, the number of genuine scores were 600, 500, 400 and 300 respectively. Although the number of genuine scores is not very high, the use of cross-validation yields statistically significant results. For evaluation, the Receiver Operating Characteristics (ROC) curve was computed, which shows the variation of False Acceptance Rate (FAR) vs. False Rejection Rate (FRR). Specific FRR readings at certain FAR rates (i.e., FAR=0.0%, 0.1%, and 1.0%) are also reported for a more detailed comparison.

C. Results

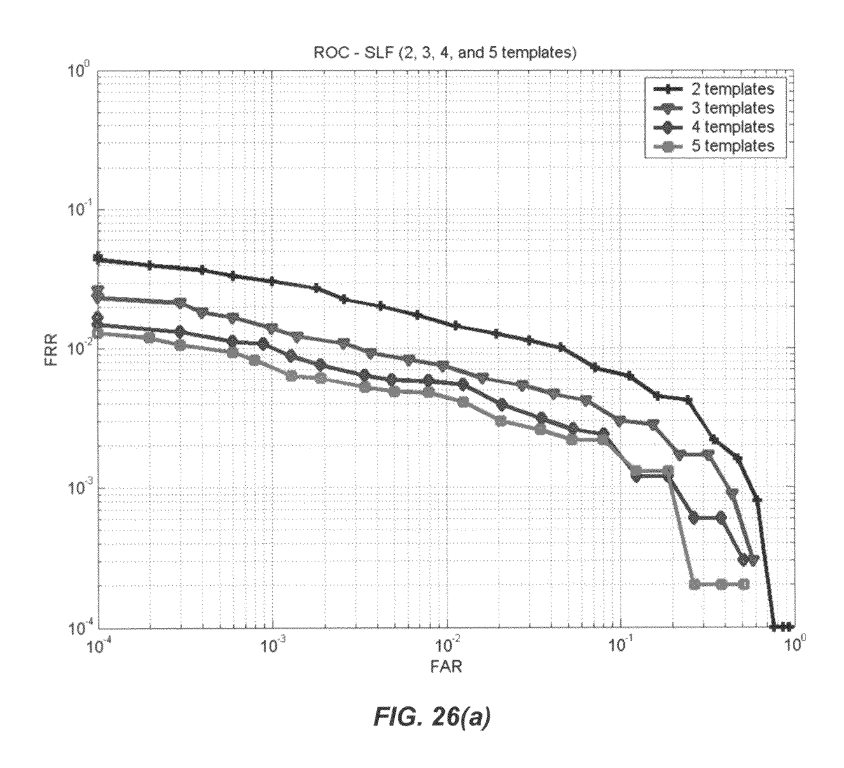

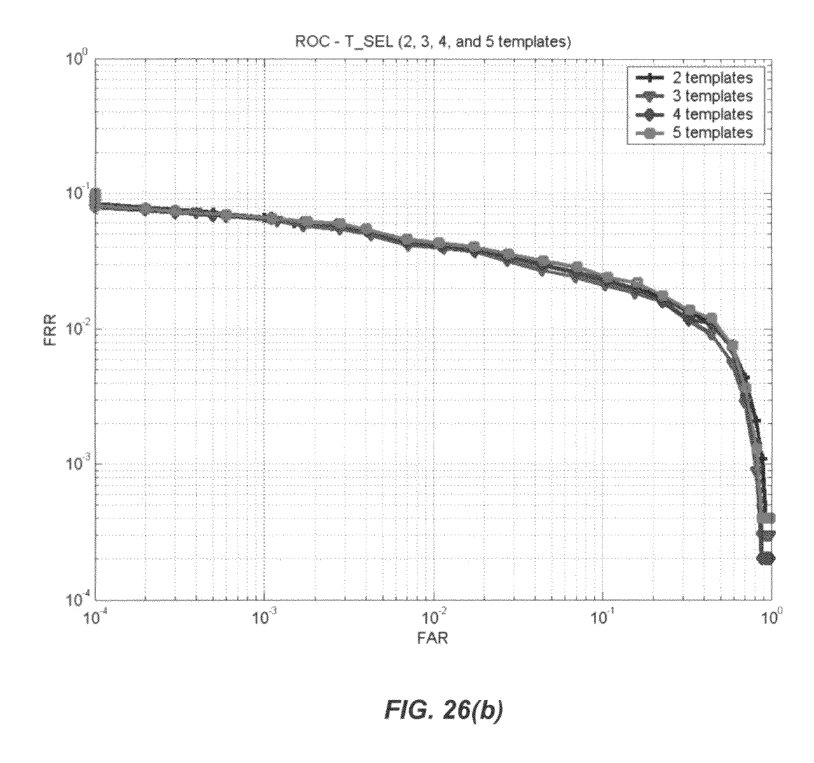

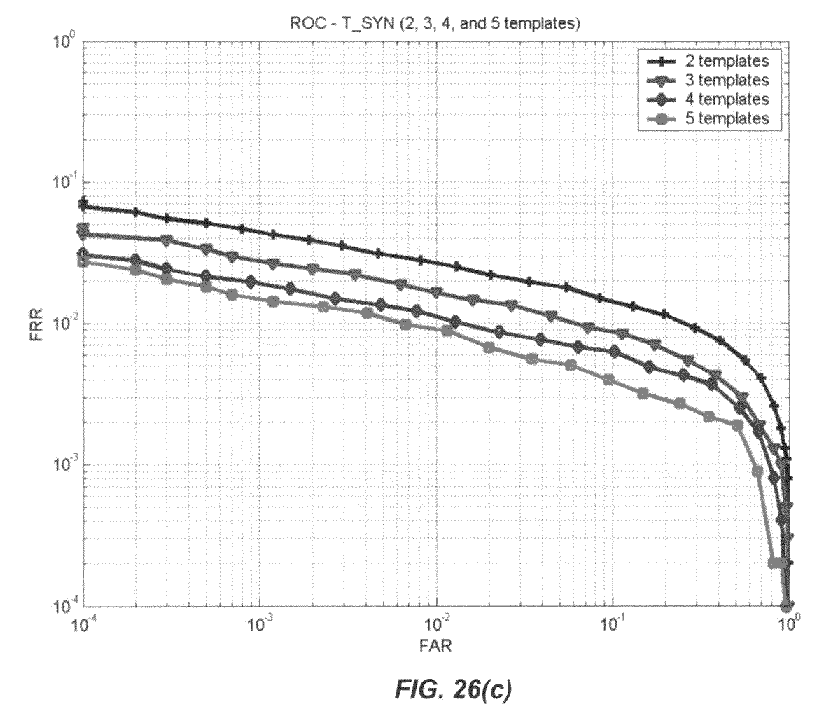

FIG. 26 compares each method (i.e., SLF, T_SEL, T_SYN) using different numbers of templates. The graphs have been logarithmically scaled for clarity. Clearly, using more enrollment templates improves the performance of T_SLF and T_SYN, however, it does not have any effect on the performance of T_SEL. Since FVC 2000 Db1 is a low quality database, it can be clearly observed that using multiple enrollment templates does make a difference in terms of accuracy and consistency. Using one template, however, as in the case of T_SEL, yields lower performance due to noisy features and small coverage area. Overall, T_SEL performed worst compared to SLF and T_SYN, especially when increasing the number of enrollment templates.

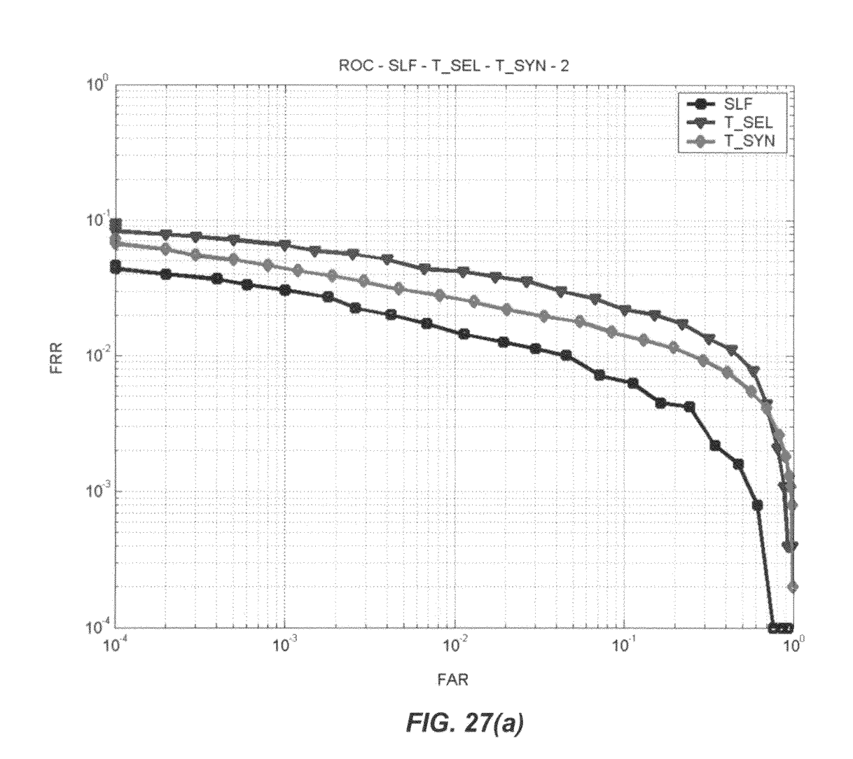

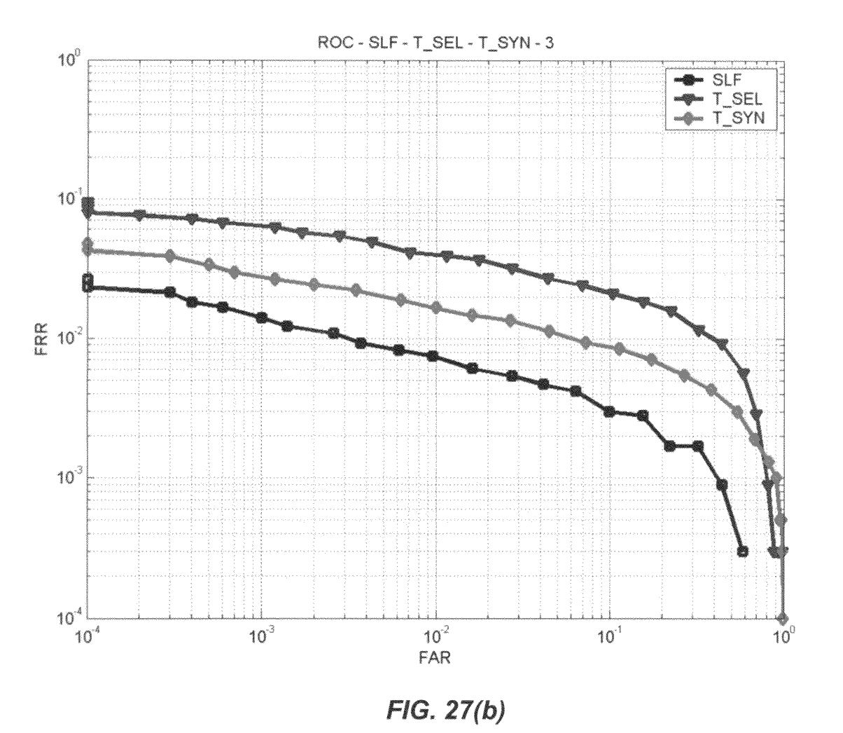

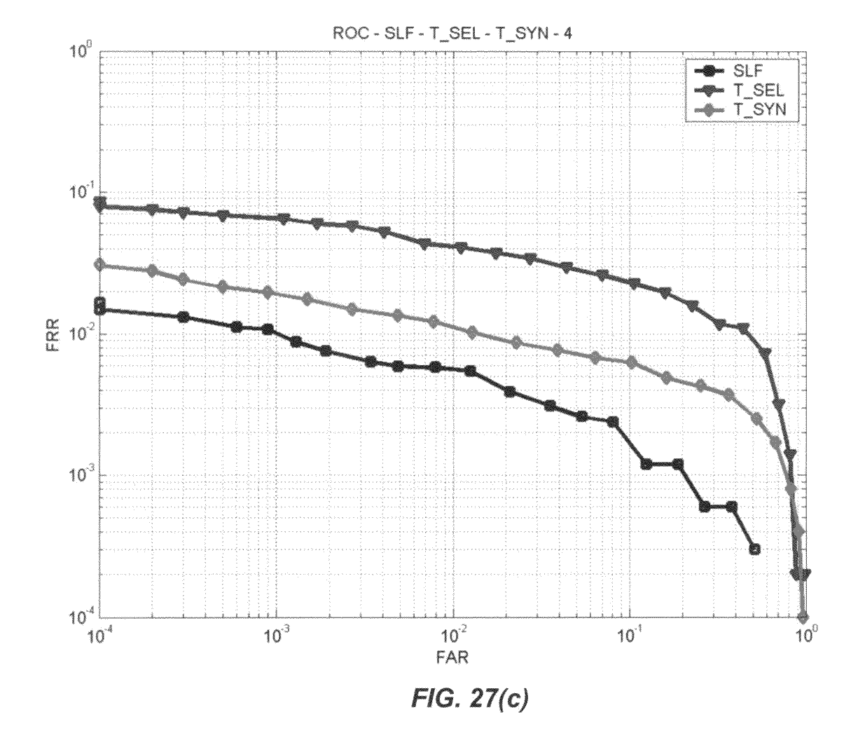

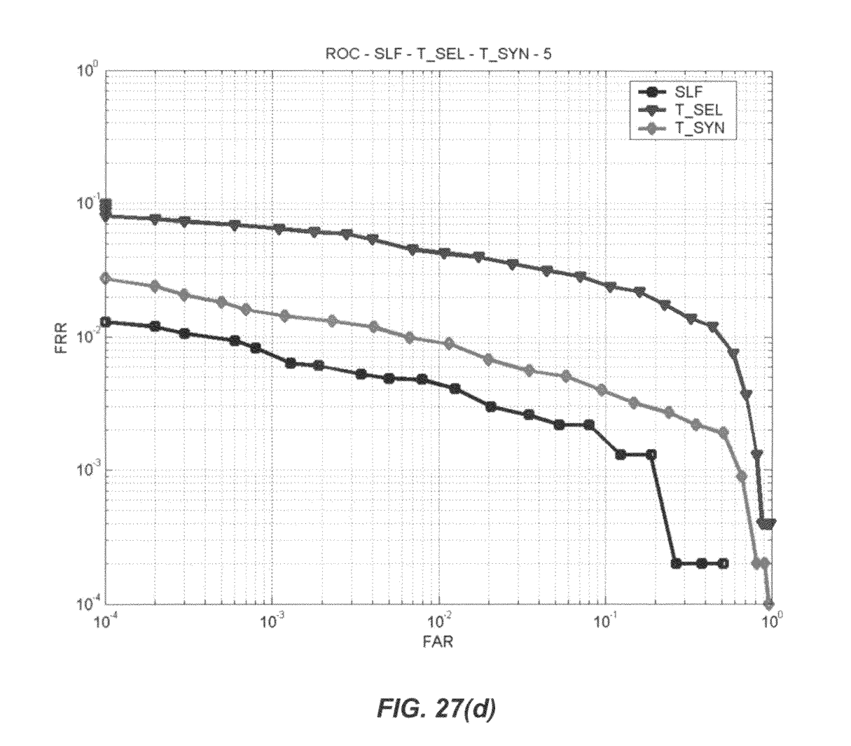

Comparing SLF with T_SYN, it was found that SLF performed slightly better than T_SYN, but performance differences got smaller with increasing the number of enrollment templates or FAR rate, as shown in FIG. 27. TABLE I shows some specific FRR readings at certain FAR values, for a more detailed comparison. An analysis of the results revealed that the main reason that T_SYN did not outperform SLF was because there were inaccuracies in registering the enrollment templates using the current super-template during merging. Employing more powerful registration models, instead of simply using rigid transformations followed by affine refinements, would allow building the super-templates more accurately.

TABLE I

| | | Number of Templates | | | |
|---|---|---|---|---|---|
| | | 2 | 3 | 4 | 5 |
| SLF | FRR | 5.00% | 2.92% | 1.83% | 1.53% |
| | (@FAR = | (std: 0.83) | (std: 0.69) | (std: 0.58) | (std: 0.61) |
| | 0.000) | | | | |
| | FRR | 3.25% | 1.57% | 1.03% | 0.91% |
| | (@FAR = | (std: 0.72) | (std: 0.48) | (std: 0.40) | (std: 0.48) |
| | 0.001) | | | | |
| | FRR | 1.70% | 0.76% | 0.58% | 0.48% |
| | (@FAR = | (std: 0.50) | (std: 0.26) | (std: 0.25) | (std: 0.39) |
| | 0.010) | | | | |
| T_SEL | FRR | 9.88% | 9.77% | 9.30% | 9.20% |
| | (@FAR = | (std: 1.38) | (std: 1.55) | (std: 2.20) | (std: 2.31) |
| | 0.000) | | | | |
| | FRR | 6.77% | 6.75% | 6.73% | 6.85% |
| | (@FAR = | (std: 0.95) | (std: 0.73) | (std: 1.16) | (std: 1.21) |
| | 0.001) | | | | |
| | FRR | 4.40% | 4.14% | 4.31% | 4.48% |
| | (@FAR = | (std: 0.74) | (std: 0.62) | (std: 0.92) | (std: 0.94) |
| | 0.010) | | | | |
| T_SYN | FRR | 8.71% | 5.23% | 3.90% | 3.62% |
| | (@FAR = | (std: 2.62) | (std: 1.55) | (std: 1.13) | (std: 1.19) |
| | 0.000) | | | | |
| | FRR | 4.68% | 3.10% | 2.03% | 1.60% |
| | (@FAR = | (std: 0.74) | (std: 1.03) | (std: 0.50) | (std: 0.54) |
| | 0.001) | | | | |
| | FRR | 2.81% | 1.75% | 1.23% | 0.99% |
| | (@FAR = | (std: 0.62) | (std: 0.47) | (std: 0.47) | (std: 0.48) |
| | 0.010) | | | | |

Nevertheless, although SLF performed slightly better than T_SYN in terms of verification accuracy, SLF had higher storage and time requirements compared to T_SYN. When N=4, the average storage requirements of SLF, T_SEL and T_SYN were 1540, 385 and 729 bytes respectively per user. In terms of time, T_SEL was the fastest, requiring 0.56 seconds on the average. T_SYN was faster on average than SLF, taking 1.84 seconds versus 2.24 seconds.

Table II provides some statistics on super-template minutiae counts, as well as distributions of weights. Compared to individual templates, the number of super-template minutiae increased by 25.95%, 47.46%, 65.53% and 81.46% when merging 2, 3, 4, and 5 enrollment impressions respectively. When merging 2 impressions, the percentage of minutiae having weights more than 1 was 48.46% of the total number of minutiae in the super-template. The corresponding percentages for 3, 4, and 5 impressions were 55.97%, 59.95% and 60.83%.

TABLE II
SUPER-TEMPLATE MINUTIAE AND WEIGHT
STATISTICS

| | Number of Templates | | | | |
|---|---|---|---|---|---|
| | 1 | 2 | 3 | 4 | 5 |
| Avg. # of | 32.64 | 41.11 | 48.13 | 54.03 | 59.23 |
| minutiae | | | | | |
| Weight 5 | N/A | N/A | N/A | N/A | 10.40 |
| Weight 4 | N/A | N/A | N/A | 11.79 | 7.37 |
| Weight 3 | N/A | N/A | 13.54 | 9.65 | 7.86 |
| Weight 2 | N/A | 19.92 | 12.30 | 10.95 | 10.40 |
| Weight 1 | 32.64 | 22.29 | 21.19 | 21.64 | 23.20 |

T_SYN is better suited for updating the template over time (e.g., during verification) compared to SLF. Moreover, although SLF performed slightly better than T_SYN in terms of verification accuracy, T_SYN has lower time and space requirements. It could be argued that time and space issues are not important issues at present since computers are getting faster and storage is very cheap. It should be pointed out, however, that there are applications (e.g., large-scale identification), where a single computer, acting as a server, is required to rapidly service many matches. In this case, T_SYN could be used to speed-up computations. In addition, storage could be an extremely important issue in other applications, for example, when storing the templates on identity cards. Storing the super-template instead of multiple enrollment templates would be more efficient in this case. Nevertheless, in case of applications where storage and speed may be less important that accuracy, T_SYN and SLF could be combined to improve performance. For example, multiple super-templates could be generated from the available fingerprint images by choosing different prime fingerprint templates (or even by changing the order of merging). Then, SLF could be applied using multiple super-templates.

The inability of the disclosed registration methods to merge the enrollment templates accurately was the main reason for the slightly worse performance of T_SYN compared to SLF. In the previously disclosed methods, when comparing an input template (i.e., enrollment or query) to a super-template, the Delaunay triangulation of the input template are compared to the Delaunay triangulation hierarchy of the super-template. However, one could also represent the input template by a hierarchy of Delaunay triangulations. For example, this can be done by assigning a quality index to the minutiae of the input template (e.g., using NIST's fingerprint processing software), and representing them by a Delaunay triangulation hierarchy, similarly to the super-templates. In this case, a comparison would be made between the minutiae of the different levels of corresponding Delaunay hierarchies. This would increase matching time, but might improve matching results significantly.

While the foregoing disclosure sets forth various methods and apparatus using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature, since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

### APPENDIX A

### Delaunay Triangulation

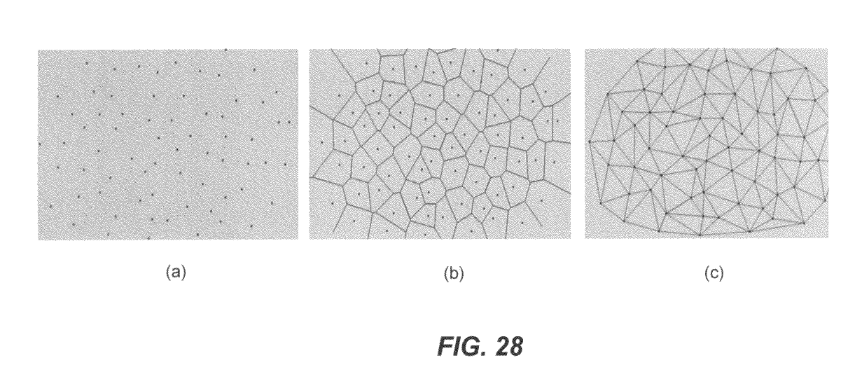

Given a set S of points p₁, p₂, . . . , p_{N}, the Delaunay triangulation of S may be computed by first computing its Voronoi diagram. The Voronoi diagram decomposes the 2D space into polygonal regions around each point pᵢ such that all the points in the region of pᵢ closer to pᵢ than to any other point in S. Given the Voronoi diagram, the Delaunay triangulation can be formed by connecting the centers of every pair of neighboring Voronoi polygons. FIG. 28(a) shows a set of 2D points; their Voronoi diagram is shown in FIG. 28(b); and their Delaunay triangulation is shown in FIG. 28(c).

The Delaunay triangulation has some advantageous properties, including: (1) it assumes a non-degenerate set of points, (2) a circle through the three points of a Delaunay triangle contains no other points, and (3) the minimum angle across all the angles in all the triangles in a Delaunay triangulation is greater than the minimum angle in any other triangulation of the same points. Property 1 allows Delaunay triangles to be used for matching. Property 2 implies that inserting a new point affects only the Delaunay triangles whose circumcircles contain that point. This implies that missing/spurious minutiae would affect the Delaunay triangulation only locally. In a comparative study involving several well known topological structures [30], the Delaunay triangulation was found to have the best structural stability under random positional perturbations. The last property implies that the Delaunay triangles would not be skinny. This is useful in the context of the disclosed methods since using skinny triangles to compute alignment transformations between fingerprints can lead to serious instabilities and errors.

The Delaunay triangulation and the Voronoi diagram can be computed very efficiently, since the number of edges in both cases is of the order of O(N). Since each edge belongs to at most two triangles or polygons, the number of triangles generated by the Delaunay triangulation is also linear to the number of points. In the experiments discussed herein, Fortune's implementation of Delaunay triangulation was used. Fortune's implementation is available from http://netlib.bell-labs.com/netlib/voronoi. The complexity of the triangulation method is O(NlogN).

### APPENDIX B

### References

[1] S. Pankanti, S. Prabhakar, and A. Jain, “On the individuality of fingerprints,” in IEEE Conference on Computer Vision and Pattern Recognition, 2001, pp. 805-812.
[2] D. Maltoni, D. Maio, A. Jain, and S. Prabhakar, Handbook of Fingerprint Recognition, Springer-Verlag, 2003.
[3] H. Lee and R. Gaensslen, Advances in Fingerprint Technology, 2nd Edition, Elsevier, New York, 2001.
[4] G. Bebis, T. Deaconu, and M. Georgiopoulos, “Fingerprint identification using delaunay triangulation,” in IEEE Conference on Information, Intelligence and Systems, 1999, pp. 452-459.
[5] A. Jain, U. Uludag, and A. Ross, “Biometric template selection: A case study in fingerprints,” in Audio- and Video-based Biometric Person Authentication Conference, 2003, pp. 335-342.
[6] X. Jiang and Ser W., “Fingerprint template improvement,” IEEE Transactions on Pattern Analysis and Machine Intelligence, vol. 24, no. 8, pp. 1121-1126, August 2002.
[7] N. Ratha, J. Connell, and R. Bolle, “Image mosaicing for rolled fingerprint construction,” in International Conference on Pattern Recognition, 1998, pp. 1651-1653.
[8] S. Shah, A. Ross, J. Shah, and S. Crihalmeanu, “Fingerprint mosaicing using thin plate splines,” in The Biometric Consortium Conference, September 2005.
[9] K. Toh, W. Yau, X. Jiang, T. Chen, J. Lu, and E. Lim, “Minutiae data synthesis for fingerprint identification applications,” in IEEE International Conference on Image Processing, 2001, pp. 262-265.
[10] A. Jain and A. Ross, “Fingerprint mosaicking,” in IEEE International Conference on Acoustics, Speech, and Signal Processing, 2002.
[11] Y. Zhang, J. Yang, and H. Wu, “A hybrid swipe fingerprint mosaicing scheme,” in Audio- and Video-based Biometric Person Authentication Conference, Rye Brook, N.Y., July 2005, pp. 131-140.
[12] K. Choi, H. Choi, and J. Kim, “Fingerprint mosaicking by rolling and sliding,” in Audio- and Video-based Biometric Person Authentication Conference, Rye Brook, N.Y., July 2005, pp. 260-269.
[13] W. Yau, K. Toh, D. Jiang, T. Chen, and J. Lu, “On fingerprint template synthesis,” in International Conference on Control, Automation, Robotics and Vision, 2001.
[14] Y. Moon, H. Yeung, K. Chan, and S. Chan, “Template synthesis and image mosaicking for fingerprint registration: An experimental study,” in IEEE International Conference on Acoustics, Speech, and Signal Processing, 2004, pp. 409-412.
[15] W C. Ryu, Y. Han, and H. Kim, “Super-template generation using successive bayesian estimation for fingerprint enrollment,” in Audio- and Video-based Biometric Person Authentication, 2005, pp. 710-719.
[16] A. Ross, S. Shah, and J. Shah, “Image versus feature mosaicing: A case study in fingerprints,” in SPIE Conference on Biometric Technology for Human Identification III, 2006, pp. 620208-1-620208-12.
[17] H. Deng and Q. Huo, “Minutiae matching based fingerprint verification using delaunay triangulation and aligned-edge-guided triangle matching,” in Audio- and Video-based Biometric Person Authentication Conference, 2005, pp. 270-278.
[18] A. Ross and R. Mukherjee, “Augmenting ridge curves with minutiae triplets for fingerprint indexing,” in SPIE Biometric Technology for Human Identification IV, 2006, vol. 6539.
[19] N. Liu, Y. Yin, and H. Zhang, “A fingerprint matching algorithm based on delaunay triangulation net,” in IEEE International Conference on Computer and Information Technology, 2005, pp. 591-595.
[20] G. Parziale and A. Niel, “A fingerprint matching using minutiae triangulation,” in International Conference on Biometric Authentication, 2004, pp. 241-248.
[21] C. Wang and M. Gavrilova, “Delaunay triangulation algorithm for fingerprint matching,” in IEEE International Symposium on Voronoi Diagrams in Science and Engineering, 2006, pp. 208-216.
[22] X. Liang, T. Asano, and A. Bishnu, “Fingerprint matching using minutia polygons,” in International Conference on Pattern Recognition, 2006, pp. 1046-1049.
[23] R. Germain, A. Califano, and S. Colville, “Fingerprint matching using transformation parameter clustering,” IEEE Computational Science and Engineering, vol. 4, no. 4, pp. 42-49, 1997.
[24] S. Skiena, The algorithm design manual, Springer-Verlag, New York, 1998.
[25] “Nist fingerprint image software,” NFIS, National Institute of Standards and Technology.
[26] “Verifinger fingerprint identifications system,” http://www.neurotechnologija.com/verifinger.html.
[27] D. Maio, D. Maltoni, R. Capelli, J. Wayman, and A. Jain, “Fvc2000: Fingerprint verification competition,” in International Conference on Pattern Recognition, 2000.
[28] D. Kwon, I. Yun, and S. Lee, “A robust warping method for fingerprint matching,” in IEEE International Conference on Computer Vision and Pattern Recognition, 2007, pp. 1-6.
[29] A. Ross, S. Dass, and A. Jain, “A deformable model for fingerprint matching,” in Pattern Recognition, 2005, vol. 38, pp. 95-103.
[30] M. Tuceryan and T. Chorzempa, “Relative sensitivity of a family of closest-point graphs in computer vision applications,” Pattern Recognition, vol. 24, no. 5, pp. 361-373, 1991.

What is claimed is:

1. A method of determining a match between a candidate template and a super-template, the method comprising:
using the super-template to identify i) spatial coordinates for a plurality of minutiae that define an object, and ii) a quality associated with each minutiae;
for sets of the super-template minutiae having at least two defined minutiae qualities, computing at least one Delaunay triangle for each set; and
determining a match between the candidate template and the super-template by determining a correspondence of Delaunay triangles in the candidate and super-templates, which correspondence results in an alignment of at least some minutiae of the candidate template with at least some minutiae of the super-template.

2. The method of claim 1, wherein at least some of the super-template minutiae are included in more than one of the sets of super-template minutiae.

3. A method of determining a best match between a candidate template and a super-template, the method comprising:
using the super-template to identify i) spatial coordinates for a plurality of minutiae that define an object, and ii) a quality associated with each minutiae;
for each of a plurality of iterations, wherein each iteration is associated with one of a plurality of defined minutiae qualities,
determining a correspondence between i) minutiae identified by the candidate template, and ii) minutiae in the super-template having the defined minutiae quality; and
in response to the determined correspondence, registering the candidate template with the super-template; and
in response to one or more match criteria, identifying one of the registrations between the candidate template and the super-template as a best match between the candidate template and the super-template.

4. The method of claim 3, wherein registering the candidate template with the super-template comprises:
transforming the spatial coordinates of the minutiae of the candidate template, in response to the determined correspondence.

5. The method of claim 4, wherein transforming the spatial coordinates of the minutiae of the candidate template comprises applying affine transformations to the minutiae of the candidate template.

6. The method of claim 3, wherein the object is a fingerprint.

7. The method of claim 3, wherein the minutiae qualities comprise frequencies of occurrence of the minutiae in a plurality of enrollment templates of the object.

8. The method of claim 3, wherein for at least one of the iterations:
the correspondence between i) the minutiae identified by the candidate template and ii) the minutiae in the super-template having the defined minutiae quality is determined by comparing a) minutiae triangles formed from the minutiae identified by the candidate template to b) minutiae triangles formed from the minutiae in the super-template having the defined minutiae quality.

9. The method of claim 8, further comprising:
identifying the minutiae triangles from respective Delaunay triangulations of i) the minutiae identified by the candidate template, and ii) the minutiae in the super-template having the defined minutiae quality.

10. The method of claim 3, wherein for at least one of the iterations:
determining the correspondence between i) the minutiae identified by the candidate template, and ii) the set of minutiae in the super-template having the defined minutiae quality comprises,
determining a correspondence between i) pairs of minutiae triangles identified by the candidate template and ii) pairs of minutiae triangles identified by the minutiae in the super-template having the defined minutiae quality;
computing local minutiae transforms supported by corresponding pairs of minutiae triangles; and
for each local transform supported by multiple corresponding pairs of minutiae triangles, computing a global minutiae transform supported by the multiple corresponding pairs of minutiae triangles; and
wherein the candidate template is registered with the super-template in response to a minutiae transform that fits a greatest number of minutiae in the candidate template to the minutiae in the super-template.

11. The method of claim 10, wherein determining a correspondence between i) the pairs of minutiae triangles identified by the candidate template and ii) the pairs of minutiae triangles identified by the minutiae in the super-template having the defined minutiae quality comprises:
determining a correspondence of minutiae orientation between i) the pairs of minutiae triangles identified by the candidate template and ii) the pairs of minutiae triangles identified by the minutiae in the super-template having the defined minutiae quality.

12. The method of claim 11, wherein:
the object is a fingerprint; and
the minutiae orientations are orientations of fingerprint ridges.

13. The method of claim 3, wherein:
the iterations are performed hierarchically, beginning with an iteration encompassing a higher minutiae quality and ending with an iteration encompassing a lower minutiae quality; and
for at least one of the iterations:
the correspondence between i) the minutiae identified by the candidate template and ii) the minutiae in the super-template having the defined minutiae quality is determined by comparing a) minutiae triangles formed from the minutiae identified by the candidate template to both of b) minutiae triangles formed from the minutiae in the super-template having the defined minutiae quality and c) minutiae triangles of the candidate template and the super-template that were registered in prior iterations.

14. The method of claim 3, wherein each iteration is associated with a defined minutiae quality that captures all minutiae having a quality greater than ‘x’, where ‘x’ differs for each iteration.

15. The method of claim 3, further comprising:
using the registration identified as the best match to merge at least some of the minutiae identified by the candidate template into the super-template; and
updating the minutiae qualities of the minutiae in the super-template by combining minutiae qualities of corresponding minutiae in the candidate template and the super-template.

16. The method of claim 3, further comprising, when the registration identified as the best match exceeds a match threshold, authenticating an object defined by the candidate template as being a match to the object defined by the super-template.

17. A computer-readable medium comprising one or more computer-executable instructions that, when executed by a computing system, cause the computing system to determine a best match between a candidate template and a super-template by performing the actions of:
using the super-template to identify i) a plurality of minutiae that define an object, and ii) a quality associated with each minutiae;
for each of a plurality of iterations, wherein each iteration is associated with one of a plurality of defined minutiae qualities,
determining a correspondence between i) minutiae identified by the candidate template, and ii) minutiae in the super-template having the defined minutiae quality; and
in response to the determined correspondence, registering the candidate template with the super-template; and
in response to one or more match criteria, identifying one of the registrations between the candidate template and the super-template as a best match between the candidate template and the super-template.
